(19) United States
(12) Patent Application Publication
(10) Pub. No.: US 2015/0334687 A1
(43) Pub. Date: Nov. 19, 2015

(54) Using Radio Interface Layer (RIL) Protocol to Manage, Control and Communicate with Remote Devices

(71) Applicants: Thomas P. Ventulett, Atlanta, GA (US); Jonathan A. Ventulett, Atlanta, GA (US); Brian Troxell, Kennesaw, GA (US); David Petchey, Mill Valley, GA (US); Peter Kennard, Brooklyn, NY (US)

(72) Inventors: Thomas P. Ventulett, Atlanta, GA (US); Jonathan A. Ventulett, Atlanta, GA (US); Brian Troxell, Kennesaw, GA (US); David Petchey, Mill Valley, GA (US); Peter Kennard, Brooklyn, NY (US)

(73) Assignee: AIRO WIRELESS LLC, Atlanta, GA (US)

(21) Appl. No.: 14/666,195

(22) Filed: Mar. 23, 2015

Related U.S. Application Data
(63) Continuation-in-part of application No. 12/619,371, filed on Nov. 16, 2009, now Pat. No. 8,989,694.
Application No. 12/619,371 is a continuation of application No. PCT/US2008/006427, filed on May 19, 2008.
Application No. PCT/US2008/006427 is a continuation-in-part of application No. 13/870,883, filed on Apr. 25, 2013.
Application No. 13/870,883 is a continuation-in-part of application No. 12/633,349, filed on Dec. 8, 2009, now abandoned.
(60) Provisional application No. 60/930,593, filed on May 17, 2007.
(60) Provisional application No. 60/930,593, filed on May 17, 2007.
(60) Provisional application No. 61/201,445, filed on Dec. 8, 2008.
(60) Provisional application No. 61/201,445, filed on Dec. 8, 2008.

(51) Int. Cl. H04W 72/04; H04W 4/02; H04W 52/02

(52) U.S. Cl. CPC H04W 72/042; H04W 52/0212; H04W 4/02

(57) ABSTRACT

The present invention provides a system and method for remotely monitoring and managing operation of a mobile device from a central command server, the mobile device receiving, at a radio interface layer (RIL), an electronic communication from the server, the electronic communication having a header containing one or more special characters that identify whether the electronic communication is one of a plurality of RIL commands or one of a plurality of conventional mobile communications, if the electronic communication is determined to be a RIL command, performing the instructions contained in the electronic communication using a command manager and by-passing the operating system installed on the mobile device. The RIL commands enable the central command server to reduce battery consumption, activate tracking of the mobile device, and place the mobile device in emergency operating condition when the mobile device is in a remote location or hazardous environment.

### CROSS-REFERENCE TO RELATED APPLICATIONS

This application is a continuation-in-part of and claims priority benefit under 35 U.S.C. §120 to U.S. patent application Ser. No. 12/619,371, filed Nov. 16, 2009, now U.S. Pat. No. ______, entitled “System and Method for Tracking Mobile Resources During an Emergency Condition,” which is a continuation of PCT Int'l Patent Application No. PCT/US2008/06427, entitled “A System and Method for Providing Tracking for Mobile Resources over a Network,” filed May 19, 2008, both of which claim priority benefit under 35 U.S.C. §119(e) to U.S. Provisional Patent Application No. 60/930,593, filed May 17, 2007, entitled “System for Tracking Mobile Resources over a Cellular Network,” all three of which are hereby incorporated by reference in their entirety as if set forth in full herein.

This application is also a continuation-in-part of and claims priority benefit under 35 U.S.C. §120 to U.S. patent application Ser. No. 13/870,883, filed Apr. 25, 2013, entitled “System and Method for Extending the Battery Life of a Mobile Device,” which is a continuation-in-part of U.S. patent application Ser. No. 12/633,349, filed Dec. 8, 2009, entitled “System and Method for Extending the Battery Life of a Mobile Device,” now abandoned, both of which claim priority benefit under 35 U.S.C. §119(e) to U.S. Provisional Patent Application No. 61/201,445, filed Dec. 8, 2008, entitled “System and Method for Extending the Battery Life of a Mobile Device,” all three of which are hereby incorporated by reference in their entirety as if set forth in full herein.

### FIELD OF THE INVENTION

The present invention relates to protocols for communicating with mobile devices and, more particularly, to methods and systems for using the radio interface layer (RIL) for efficiently communicating, managing, and controlling a remotely-located mobile device.

### BACKGROUND OF THE INVENTION

Typically, processors are used in a variety of electronic devices, including portable computers devices, communication systems, or GPS devices. Data processors are capable of executing a variety of instructions, especially with wireless and/or mobile communication devices (such as a cellular telephone, two-way radio, personal digital assistant (PDA), laptop computer, home entertainment equipment, etc.). Processors used with such devices must be able to run a variety of complex communication programs using only a limited amount of battery power and in situations in which only limited communication bandwidth is available.

For example, for a wireless communication device to participate in wireless communications, the device includes a built-in radio transceiver (i.e., receiver and transmitter) or is coupled to an associated radio transceiver (e.g., a station for in-home and/or in-building wireless communication networks, radio frequency (RF) modem, etc.). To implement the transceiver function, a transmitter is provided which typically includes a data modulation stage, one or more intermediate frequency (IF) stages, and a power amplifier. The data modulation stage converts raw data into baseband signals in accordance with a particular wireless communication standard. The intermediate frequency stages mix the baseband signals with one or more local oscillations to produce RF signals. The power amplifier amplifies the RF signals prior to transmission via an antenna.

In addition, one or more processors and other modules are used to form a receiver, which is typically coupled to an antenna and includes a low noise amplifier, one or more intermediate frequency stages, a filtering stage, and a data recovery stage. The low noise amplifier receives inbound RF signals via the antenna and amplifies them. The intermediate frequency stages mix the amplified RF signals with one or more local oscillations to convert the amplified RF signal into baseband signals or intermediate frequency signals. The filtering stage filters the baseband signals or the intermediate frequency (IF) signals to attenuate unwanted out-of-band signals to produce filtered signals. The data recovery stage recovers raw data from the filtered signals in accordance with the particular wireless communication standard.

Because of the computational intensity (and the associated power consumption by the processor(s)) for communications transceiver functions, it is an important goal in the design of wireless and/or mobile communication devices to minimize processor and other module operations (and the associated power consumption). It is particularly crucial for mobile applications in order to extend battery life.

In addition the wireless network is in continuous communication with the remote device. The communication between the wireless network and the remote devices is a bi-directional communication in which the network and the remote device exchange messages. It is frequently desirable for the wireless network to be able communicate to a remote device information related to the network, to provide network or device configuration updates, and to activate specific functions or applications on the remote device.

The exchange of messages between the network and the remote device provides the necessary setup and configuration request to maintain connectivity between the remote device and the network. Additionally the messaging ensures a level of quality of service, provides a communication channel, and provides a status channel between the remote device and the network. The network sends messages to the remote device to manage the amount of power the remote device can use, provides the list of mobile communication base stations and their related sectors, and ensures clean hand off from one base station sector to the another base station sector.

It is often desirable to manage the performance of the remote device to ensure preservation of its battery life—especially if the mobile device is located in a remote or hazardous location and especially when it is essential to ensure the device is detectable as long as possible and to ensure battery power is preserved and used only for critical communications with the outside world. The life or safety of work forces or individual workers located in remote and/or hazardous environments often depends on their ability to communicate their status and/or location, potentially over extended periods of time and potentially in situations in which recharging of batteries is limited. Remote and/or hazardous environment include, for example, oil fields, refineries, oil platforms, mining and chemical factories.

A single individual worker located in one these hazardous and/or remote area of the world may be required to communicate periodically with a monitoring system or call center to provide location information, safety status, and/or work status. Managing battery consumption is obviously important in such situations. In addition, economic and efficient use of data transmission is not only important for preserving battery life but often necessary for locations that have limited bandwidth or communication capabilities. For example, it is often critical to ensure that an individual or group of individuals can receive standard and emergency communication and messages in situations involving emergencies, when providing remedial actions during an accident or incident, when involved with evacuations, and when coordinating arrival or pick up of equipment or personnel in such situations.

Therefore, a need exists for a method and apparatus that provides reduced power consumption so it is possible to communicate with work force in dangerous areas. Further advantages of the methods and systems described herein, as compared to conventional communication and battery consumption systems, will become apparent to one of skill in the art after reviewing the remainder of the present application with reference to the drawings and detailed description which follows.

### SUMMARY OF THE INVENTION

The present invention relates to protocols for communicating with mobile devices and, more particularly, to methods and systems for using the Radio Interface Layer (RIL) for efficiently communicating, managing, and controlling a remotely-located mobile device.

The Radio Interface Layer communication protocol also provides a means to extend the battery life of a mobile device because the RIL communication protocol can control the activation and de-activation of certain components and applications on the remote mobile device without having to activate or power-up the remote device fully.

The method includes determining if at least one component on the mobile device can be placed into a hibernation state for a predetermined time, setting a remote clock to the current time, and powering off the at least one component on the mobile device that can be placed in the hibernation state. The method further includes waiting a predetermined interval, re-activating the at least one component on the mobile device that was placed in the hibernation state, and synchronizing a system clock with the remote clock.

Another exemplary embodiment includes a system for extending the battery life of a mobile device. Briefly described, in architecture, one embodiment of the system, among others, can be implemented as follows. The system includes a priority determination module that determines if at least one component on the mobile device can be placed in a hibernation state for a predetermined time, and a remote clock that is set to the current time of a system clock. The system further includes a deactivate module that powers off the at least one component on the mobile device that can be placed in the hibernation state, and an interrupt routine that reactivates the at least one component on the mobile device that was placed in the hibernation state after waiting a predetermined interval and synchronizes the system clock with the remote clock. A further exemplary embodiment includes a computer program product for controlling specific components of the remote device. The computer program is initiated via a RIL command to activate the remote device Global Position System, turn on or off the camera and the flash light, send a critical message, and extending the battery life of the mobile device. The computer program product including a tangible storage medium readable by the mobile device and storing instructions for execution by the mobile device for performing a method. The method includes determining if at least one component on the mobile device can be placed in a hibernation state for a predetermined time, setting a remote clock to the current time, and powering off the at least one component on the mobile device that can be placed in the hibernation state. The method further includes waiting a predetermined interval, re-activating the at least one component on the mobile device that was placed in the hibernation state, and synchronizing a system clock with the remote clock.

A further exemplary embodiment includes communicating to the device via its Radio Interface Layer. The Radio Interface Layer (RIL) is a layer of the operating system of the mobile device, which provides an interface to the radio and modem components of the mobile device. The RIL comprises two separate components: a RIL driver, which processes AT commands and events; and a RIL proxy, which manages requests from the multiple clients to the single RIL driver. RIL is an integral part of the devices' Operating System. Remote device operating systems include, for example, Symbian™ Windows Mobile™, Android™ and Apple iOS™.

The Radio Interface Layer enables wireless voice or data applications to communicate with a cellular network, such as but not limited to GSM/GPRS, CDMA2000 1X modem, HSPA, or LTE. The RIL allows OEMs to integrate a variety of modems into their equipment by providing a RIL interface. Except for Point to Point Protocol (PPP) connections, all interactions between the device's operating system and the device radio stack are via the RIL. For example, PPP connections initially use the RIL to establish the connection, but then bypass the RIL to connect directly to the virtual serial port assigned to the modem. In essence, the RIL accepts and converts all direct service requests from the upper layers (i.e., Telephony API) into commands supported and understood by the modem.

RIL standard data messages, such as but not limited to Short Message Service (SMS), Multimedia Messaging Service (MMS), high speed data, special control commands such as but not limited to Airo Telematics commands, GPS request commands, Power Management commands, are sent to the remote device's RIL. The special control commands provide, for example, methods for configuring the device hibernation conditions, time and/or event triggers, GPS performance, and related functions.

Though the Radio Interface Layer is an integral part of the operating system, the RIL provides a method to send and receive critical messages while by-passing the operating system and, correspondingly, minimizing the activation of software and hardware components on the mobile device. The RIL intercepts special function messages before such messages are received or processed by the device operating system—which enables many components and applications on the mobile device to remain powered off and inactive.

A Radio Interface Layer level message enables the mobile device to be instructed to perform critical functions without costing a lot of power usage and without having to invoke the operating system. Critical functions include, but are not limited to, initiating an emergency function in the device, obtaining the location of the device, tracking the device, turning on the flashlight or strobe light of the mobile device to help find the individual, turning off the mobile device to improve battery life, communicating critical information to a call center, sending voice or text message to the device, or sending a message to the call center using the least expensive communication method.

The special RIL messages are formatted so the RIL protocol can differentiated between a standard data message, such as an SMS or MMS, and the special RIL message. The special RIL messages are formatted starting with a preamble set of characters (for initial identification purposes), followed by specific commands and related parameters, if any, and ending with a final set of characters (for indicating end of the communication). The preamble and final set of characters, depending on the special command, can be one or many characters long. The preamble characters enable the RIL protocol to identify the message as a special RIL message rather than a conventional SMS or MMS message. The final set of characters enable the RIL protocol to identify the end of the special RIL message.

These and other aspects, features and advantages of the invention will be understood with reference to the drawing figure and detailed description herein, and will be realized by means of the various elements and combinations particularly pointed out in the appended claims. It is to be understood that both the foregoing general description and the following brief description of the drawing and detailed description of the invention are exemplary and explanatory of preferred embodiments of the invention, and are not restrictive of the invention, as claimed.

### BRIEF DESCRIPTION OF THE DRAWINGS

The present invention, as defined in the claims, can be better understood with reference to the following drawings. The components within the drawings are not necessarily to scale relative to each other, emphasis instead being placed upon clearly illustrating the principles of the present invention.

FIG. 1 is a block diagram illustrating an exemplary mobile device communication system according to the present invention.

FIG. 2A is a block diagram illustrating hardware components of an exemplary server for use with the communication system of FIG. 1;

FIG. 2B is a block diagram illustrating hardware components of an exemplary mobile device for use with the communication system of FIG. 1;

FIG. 2C is a block diagram illustrating various communication layers, including operating system and radio interface layers, used with the communication system of FIG. 1;

FIG. 3A is a flow chart illustrating steps performed by the server within the communication system of FIG. 1;

FIG. 3B is a flow chart illustrating steps performed by a mobile device within the communication system of FIG. 1;

FIG. 3C is a flow chart illustrating Radio Interface Layer Message Parsing steps performed by the server within the communication system of FIG. 1;

FIG. 3D is a flow chart illustrating Radio Interface Layer Message Parsing steps performed by a mobile device within the communication system of FIG. 1;

FIG. 4A is a flow chart illustrating Power Management steps performed by the server within the communication system of FIG. 1;

FIG. 4B is a flow chart illustrating Power Management steps performed by a mobile device within the communication system of FIG. 1;

FIG. 5A is a flow chart illustrating configuration process steps utilized by the server within the communication system of FIG. 1;

FIG. 5B is a flow chart illustrating configuration process steps utilized by a mobile device within the communication system of FIG. 1;

FIG. 6A is a flow chart illustrating emergency process steps utilized by the server within the communication system of FIG. 1;

FIG. 6B is a flow chart illustrating emergency process steps utilized by a mobile device within the communication system of FIG. 1;

FIG. 7A is a flow chart illustrating tracking process steps utilized by the server within the communication system of FIG. 1;

FIG. 7B is a flow chart illustrating tracking process steps utilized by a mobile device within the communication system of FIG. 1;

FIG. 8A is a flow chart illustrating negotiate communication link process steps utilized by the server within the communication system of FIG. 1;

FIG. 8B is a flow chart illustrating negotiate communication link process steps utilized by a mobile device within the communication system of FIG. 1;

FIG. 9 is a flow chart illustrating flashlight agent process steps utilized by a mobile device within the communication system of FIG. 1;

FIG. 10A is a flow chart illustrating GPS agent process steps utilized by the server within the communication system of FIG. 1; and

FIG. 10B is a flow chart illustrating GPS agent process steps utilized by a mobile device within the communication system of FIG. 1.

### DETAILED DESCRIPTION OF THE INVENTION

The present invention is applicable to remotely-located mobile devices using a Radio Interface Layer (RIL) message protocol, as described hereinafter, to manage, control, and configure components, applications, and battery usage on such remotely-located mobile devices. While described below with respect to an exemplary Power Management system, the processes, methods, and systems described herein can be used with any mobile device, such as for example but not limited to, mobile PCs, laptops, PDAs, pocket PCs, pagers, cellular phones, tablet PCs, e-book display devices, and any other portable computing device now in use or developed hereinafter.

The exemplary Radio Interface Layer message protocol described herein provides one or more of the following benefits: (1) may be integrated with remote devices to control, manage, configure the remote device without user knowledge and intervention; (2) allows remote system settings control and management; (3) permits remote configuration of simultaneous voice and data communications; (4) provides emergency communications priority message handling, and (5) selectively enables extension and preservation of battery life on a mobile device when necessary.

Mobile professionals typically carry multiple mobile computing devices on their person—all of which have specific usage and connection characteristics, making each device uniquely appropriate for certain mobile usage situations. In many situations, preserving or extending battery life is necessary based on the environment or situation in which the mobile professional works.

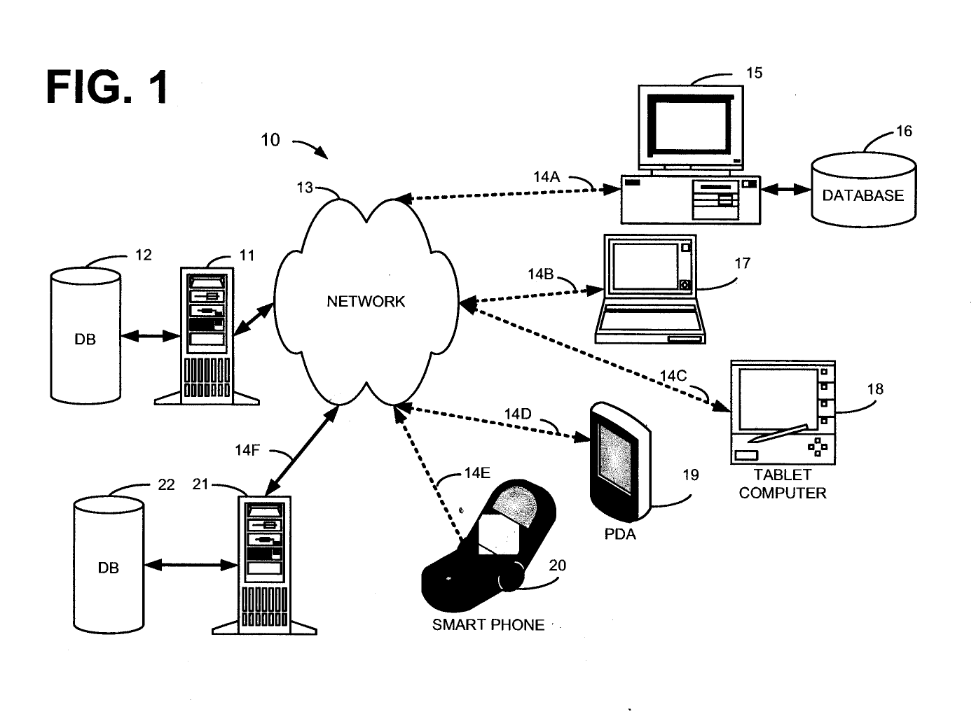

Referring now to the drawings, in which like numerals illustrate like elements throughout the several views, FIG. 1 is a block diagram illustrating an exemplary mobile device communication system 10. The exemplary mobile device communication system 10 includes a monitoring system or call center that has a computer server 11 and associated database 12. The exemplary mobile device communication system 10 also includes a plurality of remote devices 15, 17, 18, 19 and 20 in communication with the server 11 and database 12 through network 13.

Each remote device has applications installed thereon and can have access to a local, external memory or data storage 16 and/or to an internal memory or data storage (not shown). The server database 12 is capable of being accessed by remote devices 15, 17, 18, 19 and 20 via intermittent connections 14A-14E, respectively. The server 11 preferably runs administrative software for the monitoring system or call center and controls access to part or all of the network 13 and the remote devices 15, 17, 18, 19 and 20. The remote devices 15, 17, 18, 19 and 20 share the server data stored on the database 12 and may access the server 11 over network 13, which represents one or more communication pathways, including the Internet, a local area network (LAN), a wide area network (WAN), a telephone line using a modem, a wireless network, and similar communication networks.

The structure and operation of the remote call center or monitoring system enables the server 11 and the database 12 associated therewith to handle clients more efficiently than previously known systems. Particularly, the remote call center or monitoring system of the present invention provides a manner for tracking, monitoring, controlling, managing, and communicating with remotely-located mobile devices. Preferably, communications between the server 11 and remote devices 15, 17, 18, 19 and 20 make use of a Radio Interface Layer message parser, which enables the identity and IP address information associated with each respective remote device to be transmitted to the server 11 to be used for delivering and receiving data back and forth with each respective remote device.

The remote devices 15, 17, 18, 19 and 20 may each be located at remote sites. Remote devices 15, 17, 18, 19 and 20 include but are not limited to: PCs, workstations, laptops, PDAs, pocket PCs, pagers, cellular phones, satellite phones, tablet PCs, e-book display devices, and the like. Mobile devices include any of the described remote devices and any electrical device that runs on batteries.

Third party servers 21 and databases 22 can be accessed by the server 11 via connection 14F in order to obtain information, if necessary, for dissemination to the remote devices 15, 17, 18, 19 and 20. Such information can include GPS position of the remote device, or tracking an emergency situation using a remote device. Data that is obtained from third party server 21 and databases 22 can be stored on the server 11 and database 21 in order to provide later access to the remote devices 15, 17, 18, 19 and 20. It is also contemplated that for certain types of data that the remote devices 15, 17, 18, 19 and 20 can access the third-party data directly over the network 13.

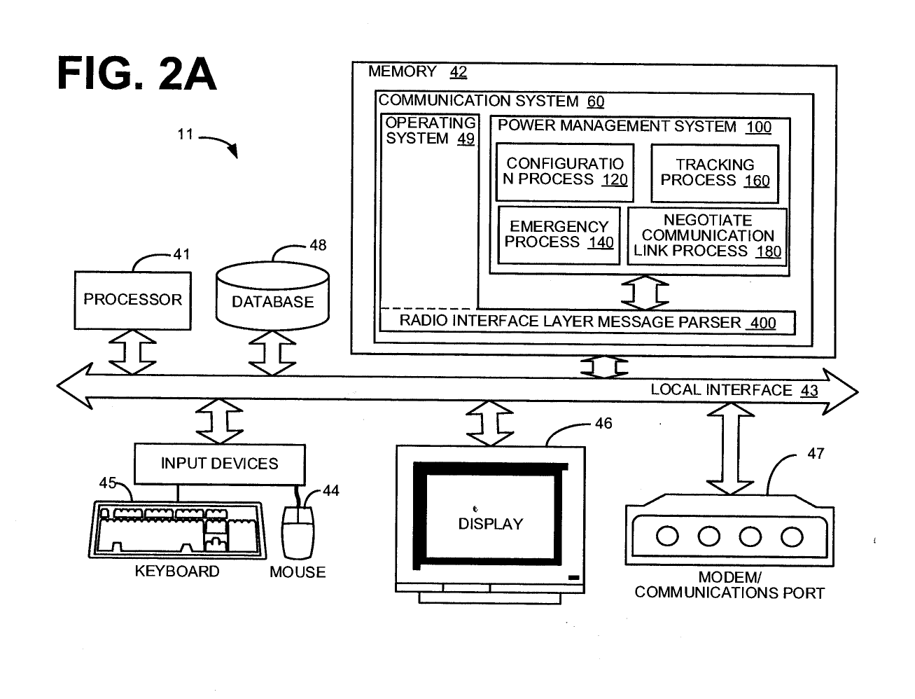

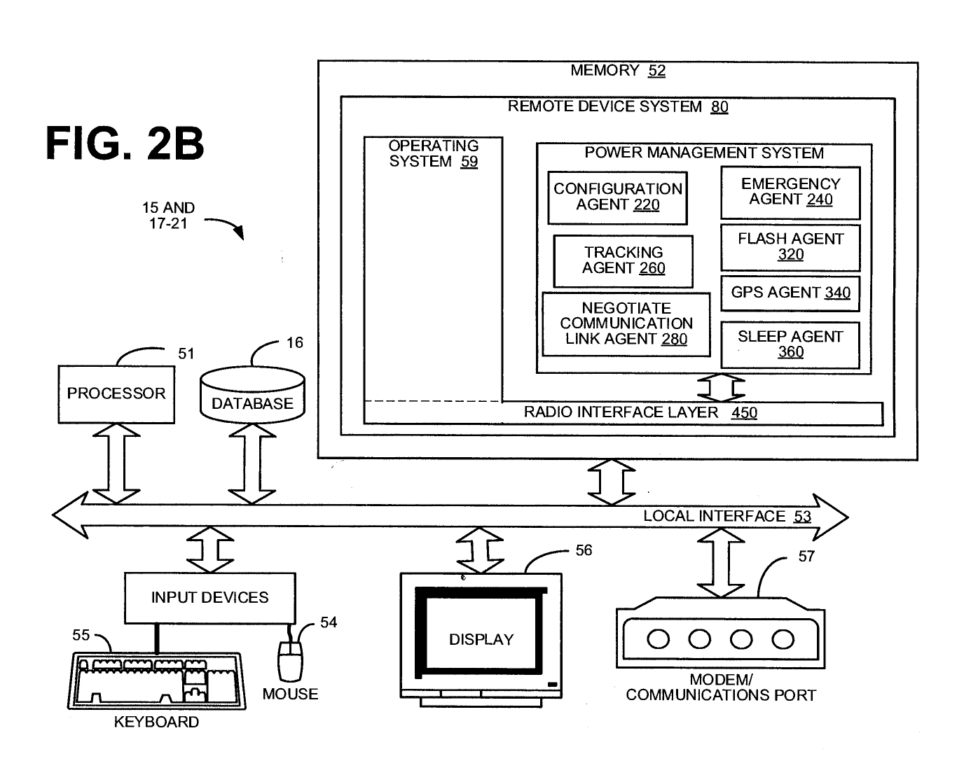

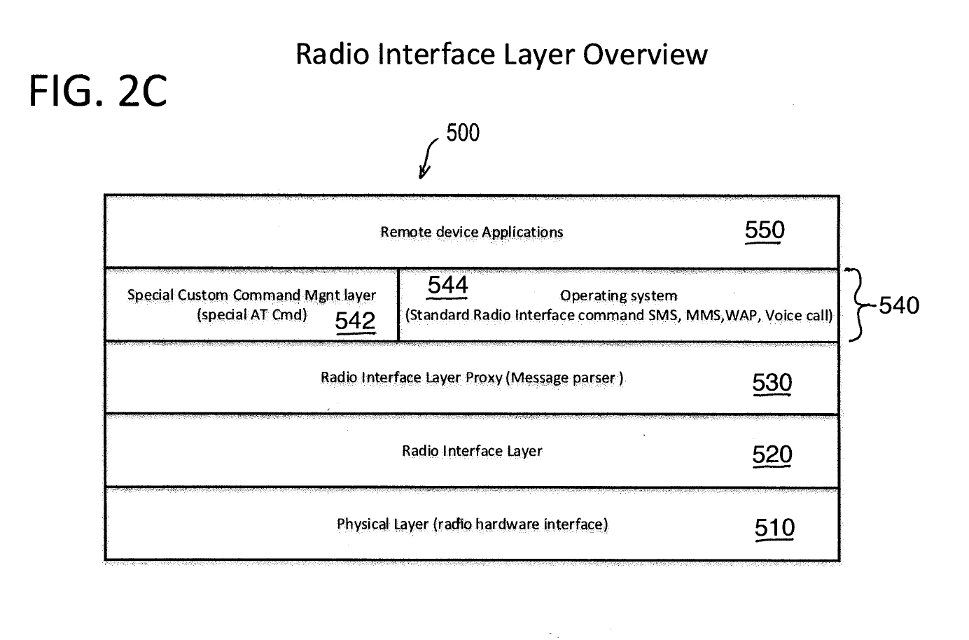

FIG. 2A is a block diagram illustrating typical hardware components and architectural arrangement of the server 11. Although not shown, third party server 21 will typically have a similar arrangement. The computer server 11 typically includes a processor 41, memory 42, and one or more input and/or output (I/O) devices (or peripherals), such as database or storage 48, that are communicatively coupled via a local interface 43. The local interface 43 can be, for example but not limited to, one or more buses or other wired or wireless connections, as is known in the art. The local interface 43 may have additional elements, which are omitted for simplicity, such as controllers, buffers (caches), drivers, repeaters, and receivers, to enable communications. Further, the local interface 43 may include address, control, and/or data connections to enable appropriate communications among the aforementioned components.

The processor 41 is a hardware device for executing software that can be stored in memory 42. The processor 41 can be virtually any custom made or commercially available processor, a central processing unit (CPU) or an auxiliary processor among several processors associated with the computer server 11, and a semiconductor based microprocessor (in the form of a microchip) or a macro processor. Examples of some suitable commercially available microprocessors include, but are not limited to: an 80×86, Pentium, Celeron, Xeon or Itanium series microprocessor from Intel Corporation, U.S.A., a PowerPC microprocessor from IBM, U.S.A., a Sparc microprocessor from Sun Microsystems, Inc, a PA-RISC series microprocessor from Hewlett-Packard Company, U.S.A., or a 68xxx series microprocessor from Motorola Corporation, U.S.A.

The memory 42 can include any one or combination of volatile memory elements (e.g., random access memory (RAM, such as dynamic random access memory (DRAM), static random access memory (SRAM), etc.)) and nonvolatile memory elements (e.g., read only memory (ROM), erasable programmable read only memory (EPROM), electronically erasable programmable read only memory (EEPROM), programmable read only memory (PROM), tape, compact disc (CD-ROM), DVD read only memory, magnetic disk, diskette, cartridge, cassette, or the like, etc.). Moreover, the memory 42 may incorporate electronic, magnetic, optical, and/or other types of storage media. Note that the memory 42 can have a distributed architecture where various components are situated remotely from one another, but still can be accessed by processor 41.

The software in memory 42 may include one or more separate programs, each of which comprises an ordered listing of executable instructions for implementing logical functions. In the example illustrated in FIG. 2A, the software in the memory 42 includes, but is not limited to, a suitable operating system (0/S) 49 and the exemplary Power Management system 100. Though the server 11 does not have a cellular radio, its memory 42 also includes a Radio Interface Layer message parser 400 to receive, send, decipher and manage messages and commands and other data communications to and from any of the remote mobile devices. The Power Management system 100 further includes the configuration process 120, emergency process 140, tracking process 160, and negotiate communication link process 180. These software components will be described in further detail in association with FIG. 2C through FIG. 10B.

A non-exhaustive list of examples of suitable commercially available operating systems 49 is as follows: (a) a Windows operating system available from Microsoft Corporation; (b) a Netware operating system available from Novell, Inc.; (c) a Macintosh operating system available from Apple Computer, Inc.; (d) a UNIX operating system, which is available for purchase from many vendors, such as the Hewlett-Packard Company, Sun Microsystems, Inc., and AT&T Corporation; (e) a LINUX operating system, which is freeware that is readily available on the Internet; (f) a run time Vxworks operating system from WindRiver Systems, Inc.; or (g) an appliance-based operating system, such as that implemented in handheld computers or personal data assistants (PDAs) (e.g., Symbian OS available from Symbian, Inc., Palm OS available from Palm Computing, Inc., and Windows Mobile available from Microsoft Corporation).

The operating system 49 essentially controls the execution of other computer programs, such as the exemplary Power Management system 100, and provides scheduling, input-output control, file and data management, memory management, and communication control and related services. However, it is contemplated that the exemplary Power Management system 100 is capable of being managed and run using any of the above-described operating systems in addition to all other commercially available operating systems.

The Power Management system 100 may be a source program, executable program (object code), script, or any other program or code comprising a set of instructions to be performed. A source program is usually translated via a compiler, assembler, interpreter, or the like, which may or may not be included within the memory 42, so as to operate properly in connection with the O/S 49. Furthermore, the Power Management system 100 can be written as (a) an object oriented programming language, which has classes of data and methods, or (b) a procedure programming language, which has routines, subroutines, and/or functions, for example but not limited to, C, C++, Pascal, BASIC, FORTRAN, COBOL, Perl, Java, ADA, and the like.

The I/O devices may include input devices, for example but not limited to, a keyboard 45, mouse 44, scanner (not shown), microphone (not shown), etc. Furthermore, the I/O devices may also include output devices, for example but not limited to, a printer (not shown), display 46, etc. Finally, the I/O devices may further include devices that communicate both inputs and outputs, for instance but not limited to, a NIC or modulator/demodulator 47 (for accessing other files, devices, systems, or a network), a radio frequency (RF) or other transceiver (not shown), a telephonic interface (not shown), a bridge (not shown), a router (not shown), etc.

If the computer server 11 is a PC, workstation, intelligent device or the like, the software in the memory 42 may further include a basic input output system (BIOS) (omitted for simplicity). The BIOS is a set of essential software routines that initialize and test hardware at startup, start the O/S 49, and support the transfer of data among the hardware devices. The BIOS is stored in some type of read-only-memory, such as ROM, PROM, EPROM EEPROM or the like, so that the BIOS can be executed when the computer is activated.

When the computer server 11 is in operation, the processor 41 is configured to execute software stored within the memory 42, to communicate data to and from the memory 42, and generally to control operations of the computer pursuant to instructions embodied in the software. The Power Management system 100 and the O/S 49 are read, in whole or in part, by the processor 41, perhaps buffered within the processor 41, and then executed.

When the exemplary Power Management system 100 is implemented in software, as is shown in FIG. 2A, it should be noted that the Power Management system 100 can be stored on virtually any computer readable medium for use by or in connection with any computer related system or method. In the context described herein, a computer readable medium is an electronic, magnetic, optical, or other physical device or means that can contain or store a computer program for use by or in connection with a computer related system or method. The Power Management system 100 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

In the context described herein, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In an alternative embodiment, where the Power Management system 100 is implemented in hardware, the Power Management system 100 can be implemented with any one or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

FIG. 2B is a block diagram illustrating typical hardware components and architectural arrangement of a typical mobile device 15, 17, 18, 19 and 20, as shown I FIG. 1. Most of the components described in FIG. 2A in conjunction with the server 11 are similar to the components found and used by the mobile device 15, 17, 18, 19 and 20—although the components tend to be smaller and/or have less capacity, size, or capability due to the smaller space and power constraints associated with mobile devices in contrast with servers.

Specifically, memory 52 contains the remote device system 80, which includes, but is not limited to, the remote device Power Management system 200, the Radio Interface Layer 450, and Operating System 59. The remote device Power Management system 200 further includes the configuration agent 220, emergency agent 240, tracking agent 260, negotiate communication link agent 280, flashlight agent 320, GPS agent 340, and sleep agent 360. The remote device Power Management system 200 and sub-components and Radio Interface Layer 450 will be described in greater detail hereinafter and with specific reference to FIGS. 2C through 10B.

When the remote device Memory 52 system is implemented in software, as is shown in FIG. 2B, it can be stored on virtually any computer readable medium for use by or in connection with any computer related system or method.

In an alternative embodiment, where the remote device system 80 is implemented in hardware, the remote device Power Management system 200 can be implemented in the same way as described above with regard to the Power Management system 100 (FIG. 2A). In the example illustrated, it is the remote device Power Management system 200 that interacts with the exemplary Power Management system 100.

FIG. 2C is a block diagram illustrating an exemplary Radio Interface Layer structure 500. The Radio Interface Layer is part of the Operating System Protocol layer structure. The Operating System Protocol structure is preferably based on the Open Systems Interconnection (OSI) standard, which is known in the art.

The first layer 510 consists of the Physical Layer, which provides the necessary hardware connectivity such as but not limited to, electrical impulses, radio signal, RS232 and Fast Ethernet hardware signals. The Physical Layer is the only interface between the hardware electrical interfaces (not shown) and the second layer 520.

The second layer 520 is the Radio Interface Layer, which provides the necessary transmission protocols to encode and decode data. The Radio Interface Layer handles flow control, synchronization, and error handling. The Radio Interface Layer is the only interface between the Physical layer 510 and the third layer 530.

The third layer 530 is the Radio Interface Layer Proxy, which is responsible for the switching and routing of messages by creating and managing logical communication paths. The Radio Interface Layer Proxy routes and forwards application error handling and message traffic control and sequence. The Radio Interface Layer Proxy is the primary interface between the Radio Interface Layer 520 and the fourth layer 540.

The fourth layer 540 is divided into two major components: the first is the Special Command Management Layer 542, which handles and manages the special AT commands described hereinafter. It decodes or encodes the special preambles and final set of characters associated with special commands, and deciphers and acts upon the special commands. The Special Command Management layer 542 recognizes and acts only upon the Special Commands—it ignores all standard AT commands. The Special Command Management interfaces directly with the Application Layer 550 but only by interfacing with specific applications on the remote device without engaging the Operating System and Operating System Standard AT Command Layer 544. The second component of this fourth layer 540 is the Operating System Standard AT Command Layer 544, which handles, acts upon, and manages all Standard AT commands and only recognizes the Standard AT commands.

The fifth layer 550 is the Application layer, which includes the applications and their related interfaces. An application may be initiated via the Special Command Layer 542 or the Operating System layer 544.

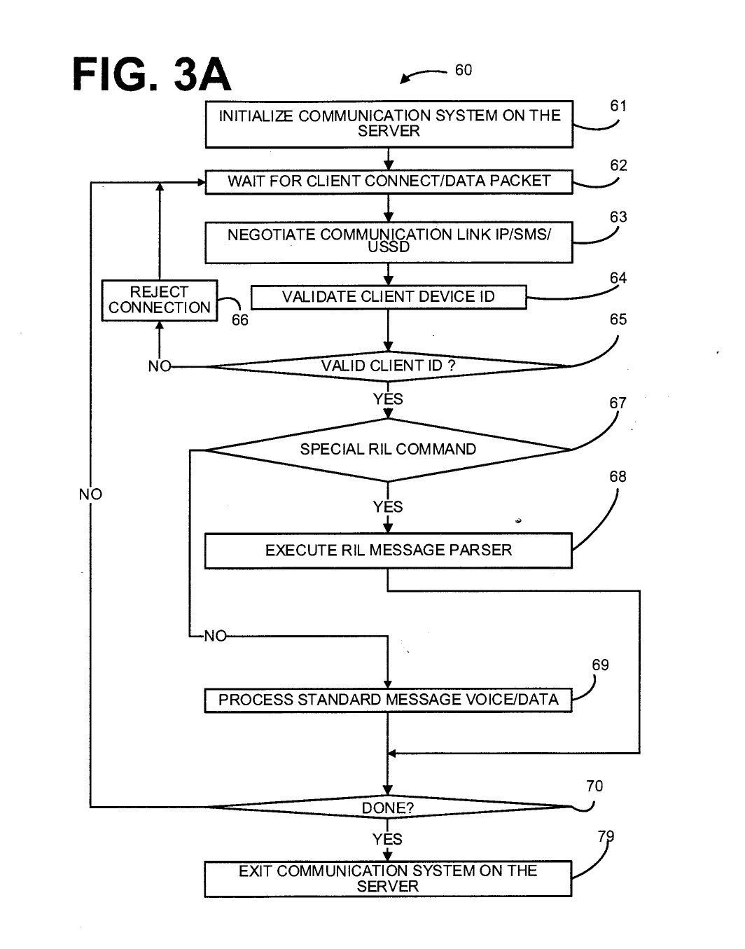

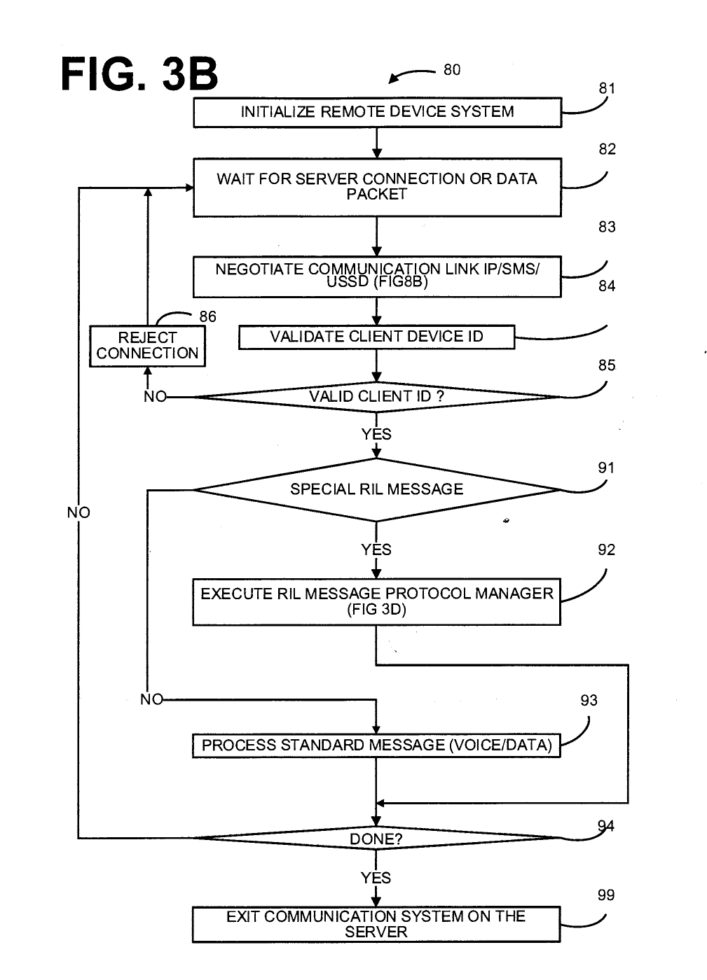

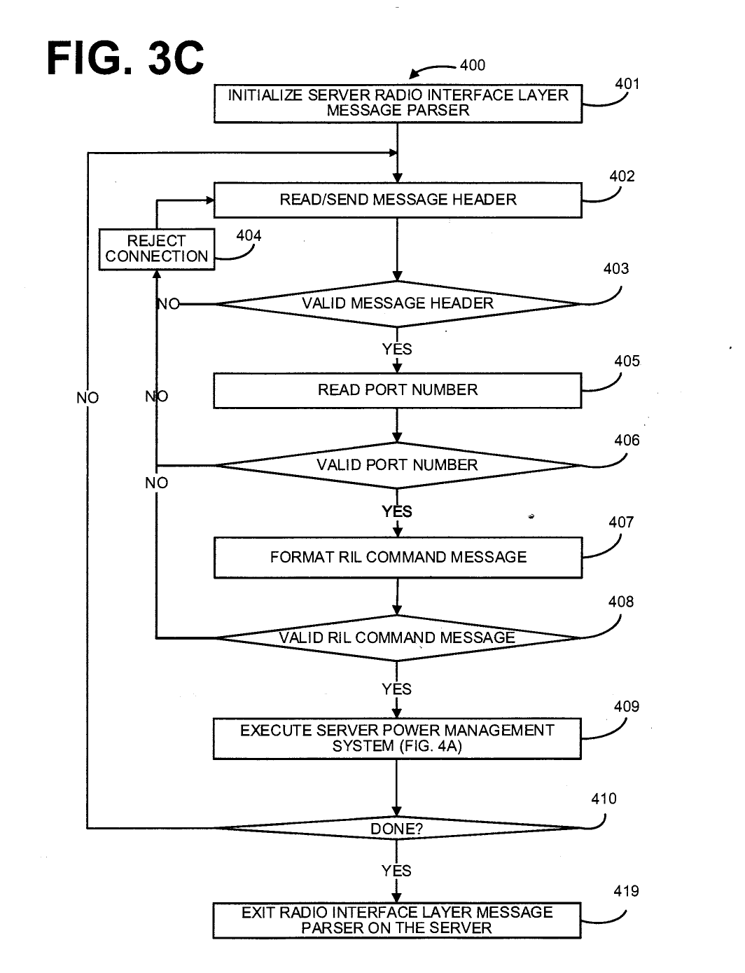

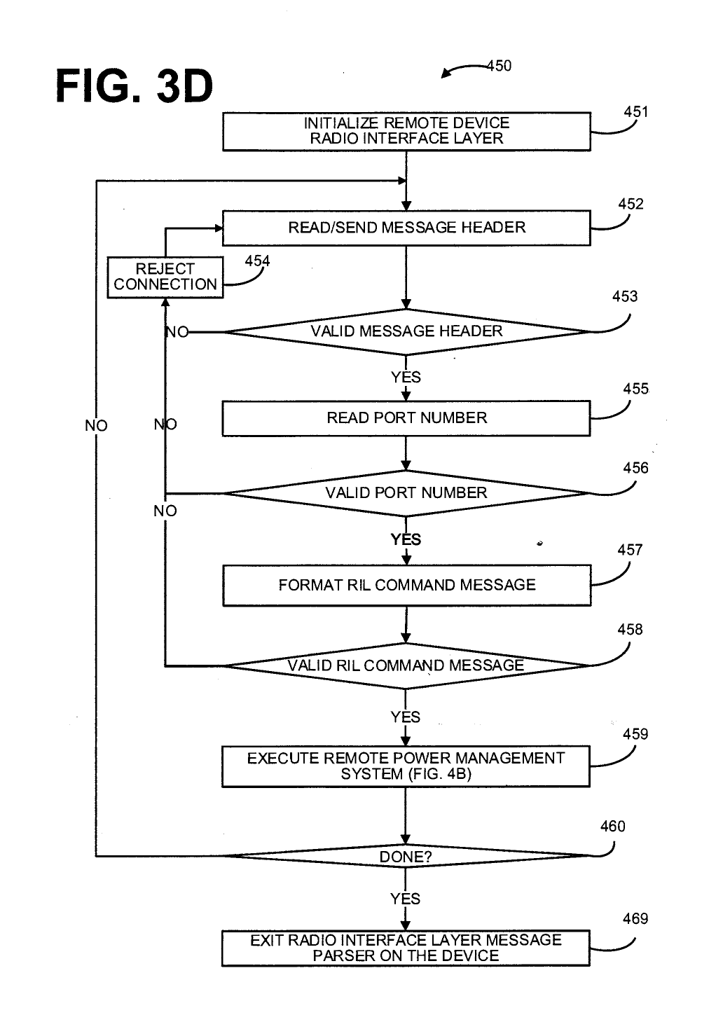

FIG. 3A is a flow chart illustrating operation of the communication system 60 with the exemplary Power Management system 100 on the server 11, as shown in FIGS. 1 and 2A. The communication system 60 negotiates the communication link to use between the server 11 and a remote mobile device 15, 17, 18, 19 and 20 and determines if the message is a standard voice or data message (e.g., SMS or MMS) or a special Radio Interface Layer command.

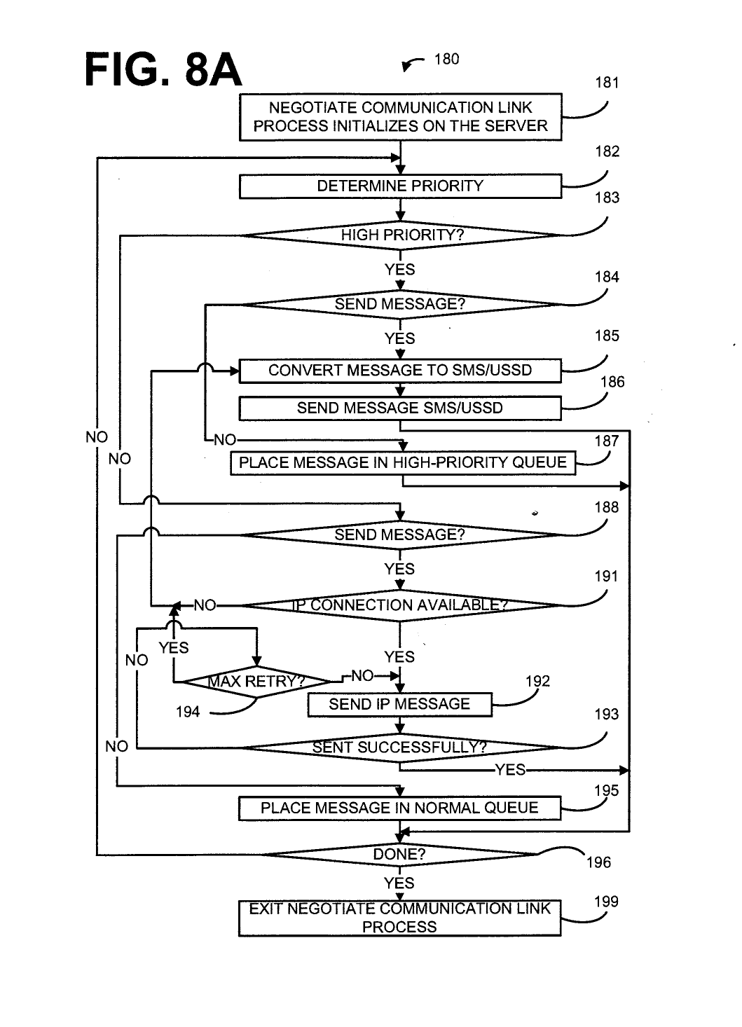

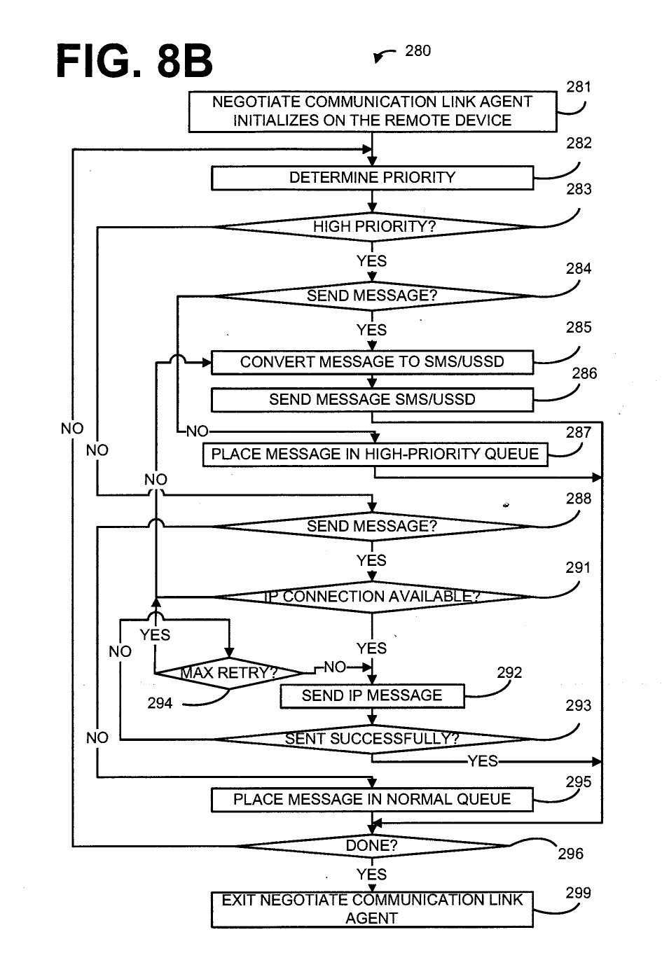

First at step 61, the communication system 60 is initialized. This initialization includes the startup routines and processes embedded in the BIOS of the server 11. The initialization also includes the establishment of data values for particular data structures utilized in the server 11 and communication system 60. At step 62, the communication system 60 waits for a client connect or data packet. Upon acquiring or sending a data packet, the communication system 60 negotiates the communication link speed. In one embodiment this connection occurs on a predetermined port. However, it is understood that other types of connections may be utilized. At step 63, the negotiate communications link process is initiated. The negotiate communications link process is described in greater detail with reference to FIG. 8A.

The communication system 60 then validates the client device ID at step 64. At step 65, it is determined if the client ID for the client connect or data packet is valid. If it is determined at step 65 that the client ID for the communication sent or received is invalid, the communication system 60 then rejects the connection in step 66 and returns to wait for the next connection at step 62.

However, if it is determined at step 65 that the client ID is valid, then the communication system 60 determines if the communication is a special Radio Interface Layer command, such as but not limited to an Airo Wireless Telematics Logic message, a Power command management message, or a Location request message, at step 67. If so, then the special RIL command is processed at step 68. Processing of the special RIL command is described in greater detail in FIG. 3C.

However, if it is determined at step 67 that the message received is a standard voice, data, or text message, then the communication system 60 processes the standard message at step 69 utilizing conventional voice and data processing techniques.

At step 70, it is determined if there are more messages to be processed. If so, then the communication system 60 returns and repeats steps 62-70. However, there are no more messages to be processed, then the communication system 60 exits at step 79.

FIG. 3B is a flow chart illustrating operation of the remote device system 80 with the remote device Power Management system 200 on a remote mobile device 15, 17, 18, 19 and 20, as shown in FIGS. 1 and 2B. The remote device system 80 negotiates the communication link to use between a remote mobile device 15, 17, 18, 19 and 20 and the server 11 and determines if the message is a standard voice or data message (e.g., SMS or MMS) or a special Radio Interface Layer command.

First at step 81, the remote device system 80 is initialized. This initialization includes the startup routines and processes embedded in the BIOS of the server 11. The initialization also includes the establishment of data values for particular data structures utilized in the server 11 and remote device system 80. At step 82, the remote device system 80 waits for a client connect or data packet. Upon acquiring or sending a data packet, the remote device system 80 negotiates the communication link speed. At step 83, the negotiate communications link process is initiated. The negotiate communications link process is described in greater detail with reference to the negotiate communications link agent is herein defined in further detail in FIG. 8B.

The remote device system 80 then validates the client device ID at step 84. At step 85, it is determined if the client ID for the client connect or data packet is valid. If invalid, the remote device system 80 then rejects the connection in step 86 and returns to wait for the next connection at step 82.

However, if it is determined at step 85 that the client ID is valid, then the remote device system 80 next determines if the communication is a Special RIL message at step 91. If so, the remote device system 80 executes the Radio Interface Link Protocol Manager at step 92. The Radio Interface Link Protocol Manager is described in greater detail in FIG. 3D.

However, if it is determined in step 91 that the message received is a standard voice, data, or text message, then the remote device system 80 processes the standard message at step 93 utilizing conventional voice and data processing techniques.

At step 94, it is determined if there are more messages to be processed. If so, then the remote device system 80 returns to repeat steps 82 through 94. However, if it is determined at step 94 that there are no more messages to be processed, then the remote device system 80 exits at step 99.

FIG. 3C is a flow chart describing operation of the exemplary Radio Interface Layer Message Parser 400 on a server 11 as shown in FIGS. 1 and 2A. The Radio Interface Layer Message Parser 400 enables the server 11 to obtain, decipher, generate, parse, and act on a Special RIL message.

First at step 401, the Radio Interface Layer Message Parser system 400 is initialized. This initialization includes the startup routines and processes embedded in the server 11. The initialization also includes the establishment of data values for particular data structures utilized in the server 11 and Radio Interface Layer Message Parser 400. At step 402, the Radio Interface Layer Message Parser reads or writes the special message header, which consists of a command preamble.

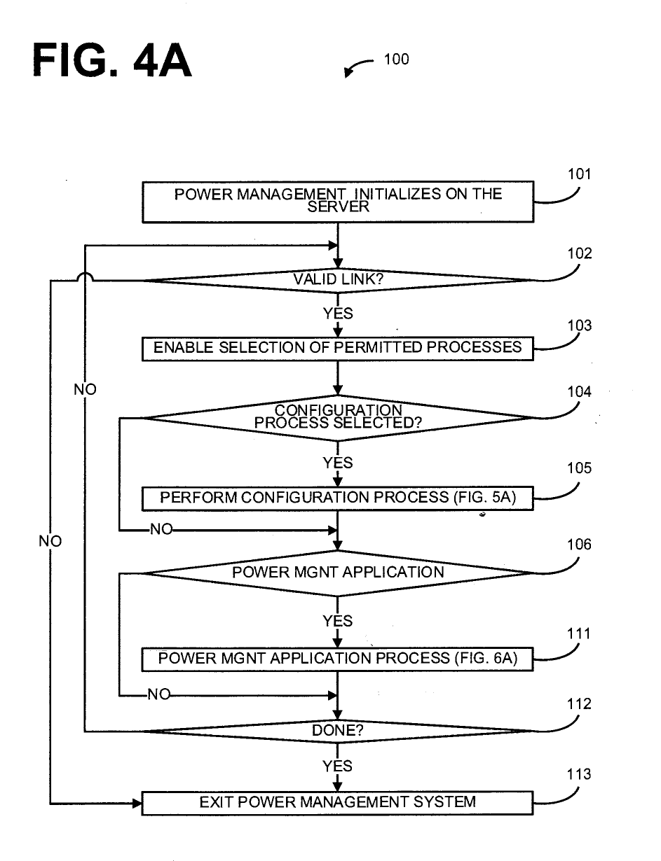

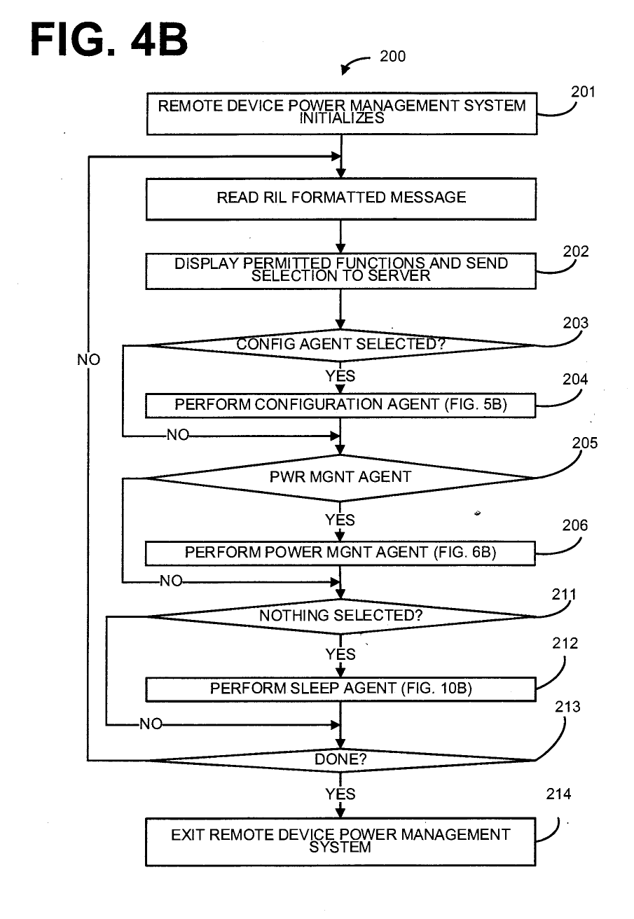

The preamble preferably consists of a special character, such as # or @, or a combination of special characters, such as @$ or ##, to mention a few. At step 403, the RIL Message Parser verifies the validity of the preamble located in the message header. If the preamble is invalid, the RIL Message Parser rejects the connection with the device at step 404. If the preamble is valid, the RIL Message Parser moves to step 405 and reads the Port number. The Port number may consist of, but is not limited to, an Internet Protocol Address or a Device identifier or device phone number, or IMEI. The Port number is validated against the data in server 11 in step 406. If the Port number is invalid, then the RIL Message Parser rejects the connection with device at step 404. If the Port number is valid, then the special RIL message is formatted at step 407. The message is then validated against the server 11 data in step 408. If the special RIL message is invalid, the RIL Message Parser rejects the connection with device. If the special RIL message is valid, RIL Message Parser executes at step 409 the Server Power Management System. The Server Power Management System is described in further detail in FIG. 4A.

At step 410, the Radio Interface Layer Message Parser determines if more messages require processing. If there are no more messages, the Radio Interface Layer Message Parser exits at step 419. If additional message require processing, the Radio Interface Layer Message Parser returns to step 402 execute step 402 to 409.

FIG. 3D is a flow chart describing an exemplary Radio Interface Layer 450 on a device, as shown in FIGS. 1 and 2B. The Radio Interface Layer 450 enables the device to obtain, decipher, generate, parse, and act on a Special RIL message.

First, at step 451, the device's Radio Interface Layer 450 is initialized. This initialization includes the startup routines and processes embedded in the BIOS of the device. The initialization also includes the establishment of data values for particular data structures utilized in the device and Radio Interface Layer 450. At step 452, the Radio Interface Layer 450 reads or writes the special RIL message header.

At step 453, the RIL 450 validates the header to ensure it consists of the correct command preamble. The preamble preferably consists of a special character, such as # or @, or a combination of special characters, such as @$ or ##, to mention a few. If the header is invalid, the RIL 450 rejects the connection with the server 11 at step 454. If the header is valid, the RIL 450 moves read the port number at step 455. The port number may consist of, but is not limited to, Internet Protocol Address or a Server Identifier or Portal. The port number is validated against the data in the device in step 456. If the port number is invalid, the RIL 450 rejects the connection with the server 11 at step 454. If the port number is valid, the Special RIL command received or to be transmitted to server 11 is read at step 457. The message is validated against the device data at step 458. If the Special RIL message is invalid, the Radio Interface Layer 450 rejects the connection with server 11 at step 454. If the message is valid, RIL 450 executes initiates the Remote Power Management System at step 459. The Remote Power Management System is described in further detail in FIG. 4B.

At step 460 the Radio Interface Layer determines if more messages require processing, if there is no more message the Radio Interface Layer exits at step 469. If additional messages require processing, the Radio Interface returns to step 452 to execute steps 452 to 459.

Illustrated in FIG. 4A is a flow chart describing operation of the exemplary Power Management system 100 on a server 11, as shown in FIGS. 1 and 2A. The Power Management system 100 enables a user to obtain and submit power management data with server 11 to be transferred to the remote mobile device 15, 17, 18, 19 and 20. The Power Management system 100 on server 11 comprises four sub-components: the configuration process 120, the emergency process 140, the tracking process 160, and the negotiate communication link process 180. After the Power Management system 100 is initialized, each of these sub-components is initialized and run in the background. Each of these sub-components processes events relevant to their own responsibility until the Power Management system 100 is shut down.

First at step 101, the Power Management system 100 is initialized. This initialization includes the startup routines and processes embedded in the BIOS of the server 11. The initialization also includes the establishment of data values for particular data structures utilized in the server 11 and Power Management system 100.

At step 102, the Power Management system 100 determines if the link the message was received on is valid. After successful connection, the remote mobile device 15, 17, 18, 19 and 20 sends its device ID and authentication information to the server 11 in order to identify itself. The message is then removed from the transmission envelope and is checked to make sure it is a valid message. If the message is a valid message, the sequence number in the message is examined to see if it is a message that has already been processed. The remote mobile device 15, 17, 18, 19 and 20 may send/receive multiple messages with the same sequence number if the remote mobile device 15, 17, 18, 19 and 20 has been out of coverage and if the server 11 has retried the transmission.

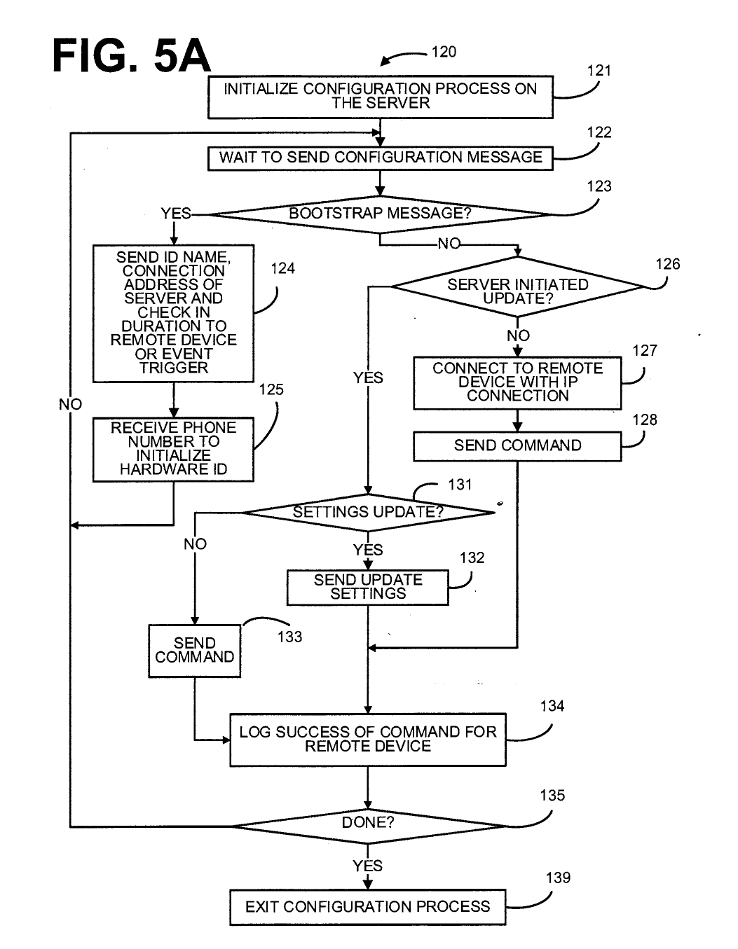

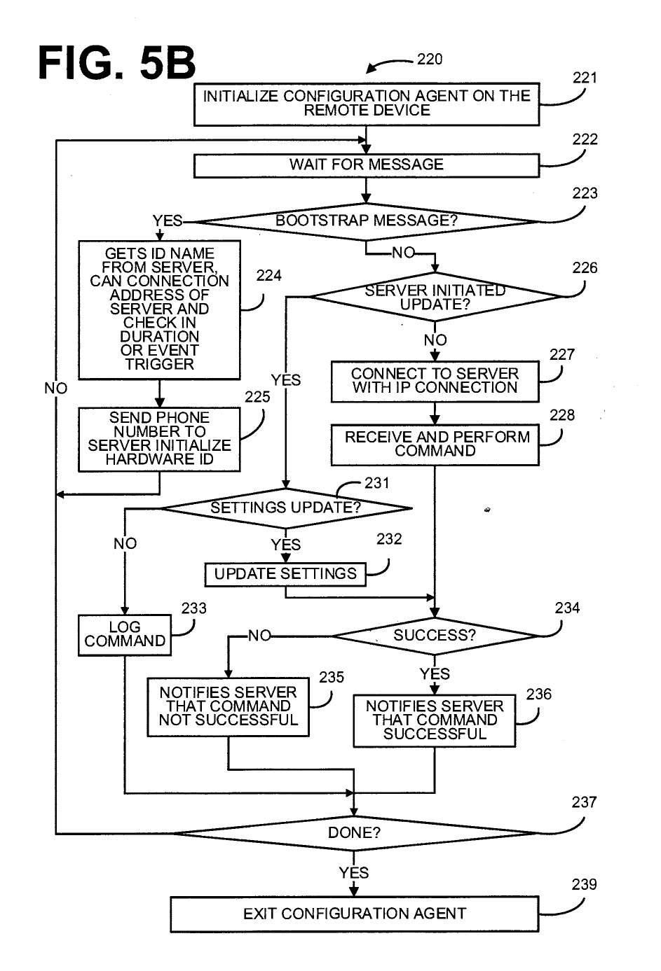

If it is determined in step 102 that the link is not valid, then the Power Management system 100 skips to exit at step 119. However, if it is determined at step 102 that link the message was received from is valid, and then the Power Management system 100 enables the selection of permitted processes at step 103. At step 104, it is determined if the configuration process is selected. If it is determined in step 104 that the configuration process was not selected, then the Power Management system 100 skips to step 106. However, if it is determined at step 104 that the configuration process was selected, then the configuration process is performed at step 105. The configuration process is herein defined in further detail in FIG. 5A.

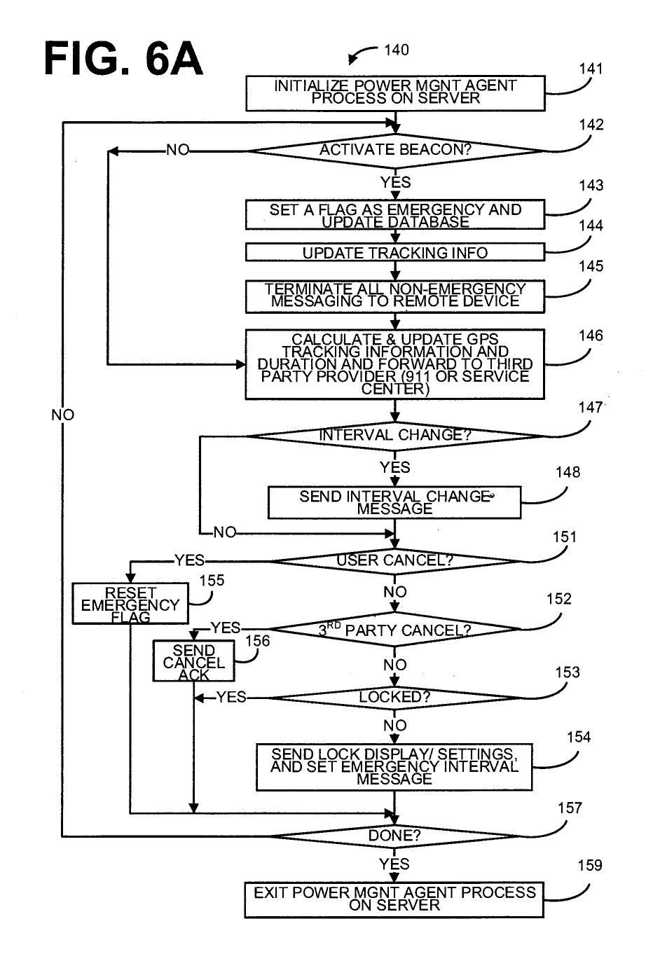

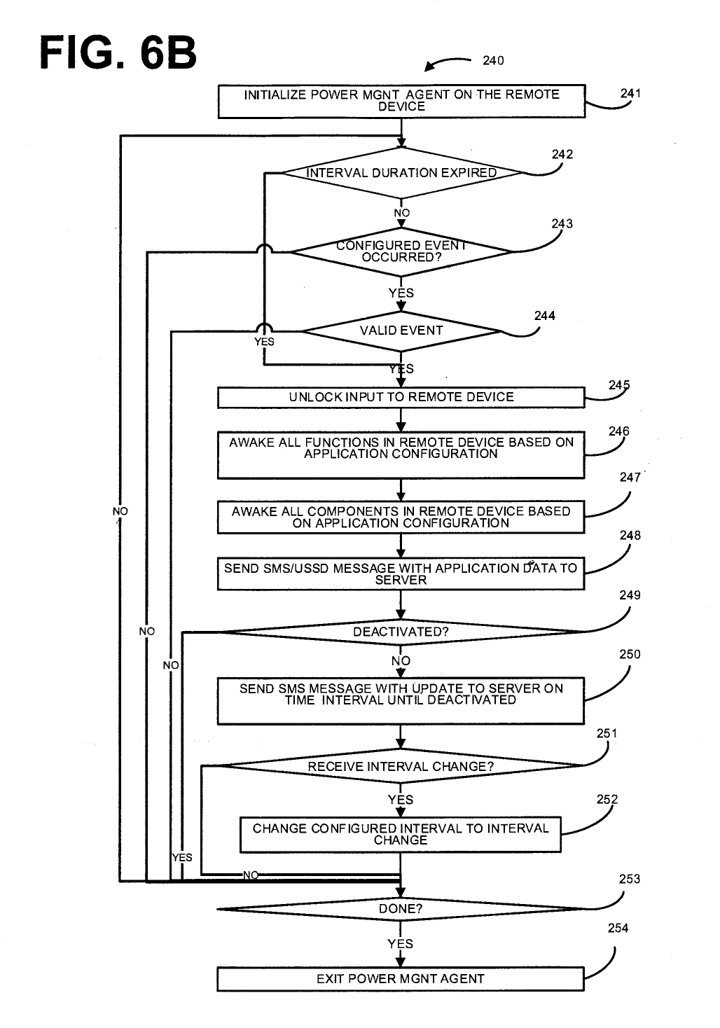

At step 106, it is determined if the emergency process is selected. If it is determined at step 106 that the emergency process is not selected, then the Power Management system 100 skips the step 112. However, if it is determined at step 106 that the emergency process was selected, then the emergency process is executed at step 111. The emergency process is herein defined in further detail in FIG. 6A.

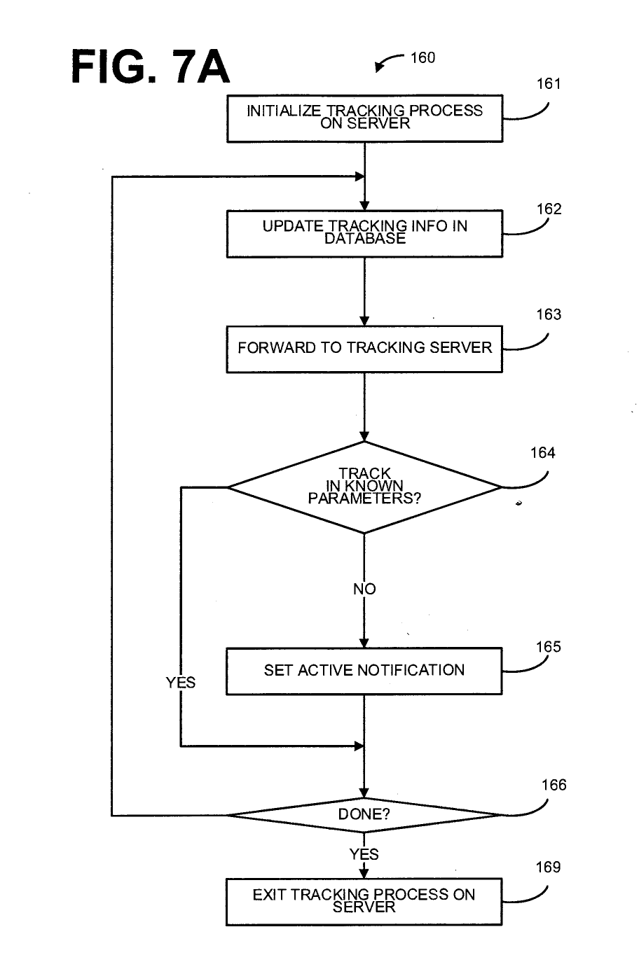

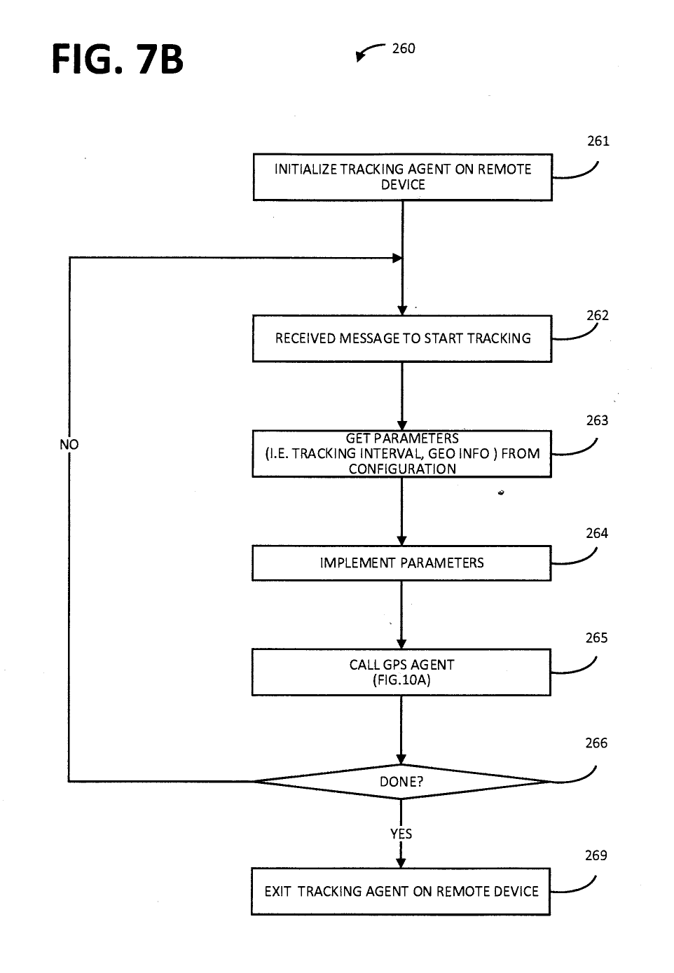

At step 112, it is determined that the tracking process is selected. If it is determined at step 112 that the tracking process was not selected, and the Power Management system 100 skips to step 114. However, if it is determined at step 112 at the tracking process was selected, then the tracking process is executed at step 113. The tracking process is herein defined in further detail in FIG. 7A.

At step 114, it is determined that there are more messages and processes to be performed. If it is determined at step 114 that there are more messages and processes to be performed, then the Power Management system 100 returns to repeat steps 102 through 114. However, if it is determined at step 114 that there are no more processes or messages to be performed, then the Power Management system 100 exits at step 119.

Illustrated in FIG. 4B is a flow chart describing an example of the operation of remote device Power Management system 200 with the battery extension system of the present invention on a remote mobile device 15, 17, 18, 19 and 20, as shown in FIGS. 1 and 2B. The remote device Power Management system 200 enables a user to obtain and submit tracking data with server 11 from the remote mobile device 15, 17, 18, 19 and 20. Remote device Power Management system 200 on remote mobile device 15, 17, 18, 19 and 20 comprises seven sub-components: the configuration agent 220, the emergency agent 240, the tracking agent 260, the negotiate communication link agent 280, the flashlight agent 320, the GPS agent 340, and the sleep agent 360 of the present invention. After the remote device Power Management system 200 is initialized, each of these sub-components is initialized and run in the background. Each of these sub-components processes events relevant to their own responsibility until the remote device Power Management system 200 is shut down.

First at step 201, remote device Power Management system 200 is initialized. This initialization includes the startup routines and processes embedded in the BIOS of the remote mobile device 15, 17, 18, 19 and 20. The initialization also includes the establishment of data values for particular data structures utilized in the remote mobile device 15, 17, 18, 19 and 20 and remote device Power Management system 200.

At step 202, remote device Power Management system 200 determines if the link the message was received on is valid. If it is determined in step 202 that the link is not valid, then remote device Power Management system 200 skips to exit at step 219. However, if it is determined at step 202 that link the message was received from is valid, then remote device Power Management system 200 displays the permitted functions and sends the selection to the server 11 at step 203. At step 204, it is determined if the configuration agent is selected. If it is determined in step 204 that the configuration agent was not selected, then remote device Power Management system 200 skips to step 206. However, if it is determined at step 204 that the configuration agent was selected, then the configuration agent is performed at step 205. The configuration agent is herein defined in further detail in FIG. 5B.

At step 206, it is determined if the emergency agent is selected. If it is determined at step 206 that the emergency agent is not selected, then remote device Power Management system 200 skips the step 211. However, if it is determined at step 206 that the emergency agent was selected, then the emergency agent is executed at step 207. The emergency agent is herein defined in further detail in FIG. 6B.

At step 211, it is determined if the tracking agent is selected. If it is determined at step 211 that the tracking agent was not selected, then remote device Power Management system 200 skips to step 213. However, if it is determined at step 211 that the tracking agent was selected, then the tracking agent is executed at step 212. The tracking agent is herein defined in further detail in FIG. 7B.

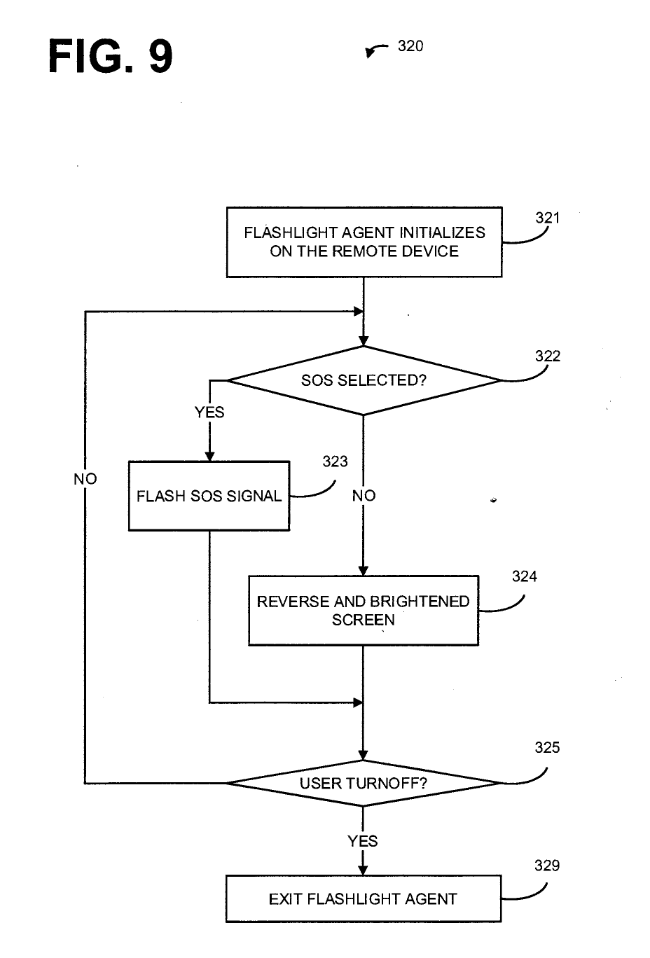

At step 213, it is determined if the flashlight agent is selected. If it is determined that step 213 at the flashlight agent is not selected, then remote device Power Management system 200 skips to step 215. However, if it is determined at step 213 that the flashlight agent was selected, then the flashlight agent is executed at step 214. The flashlight agent is herein defined in further detail in FIG. 9.

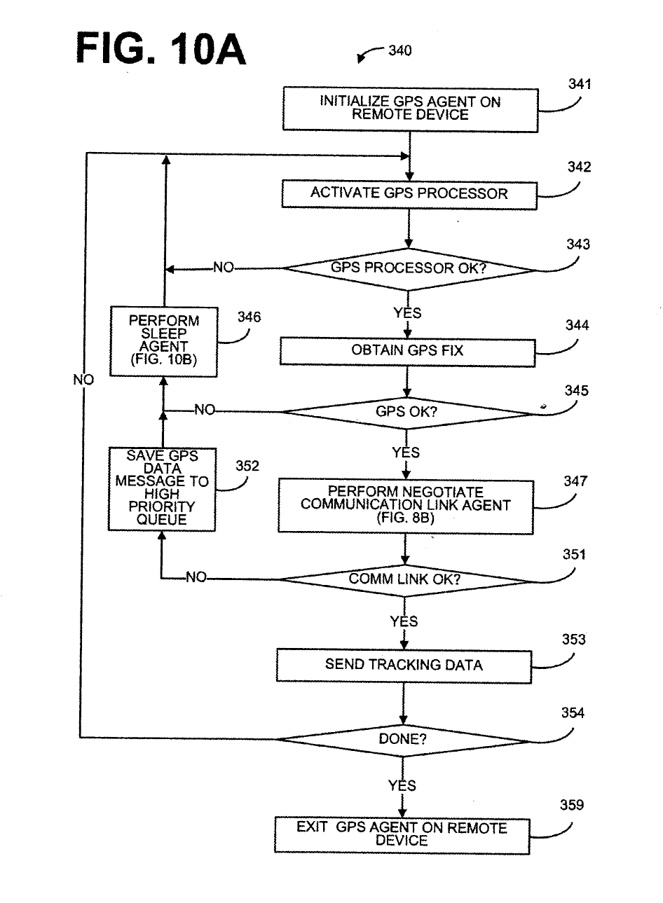

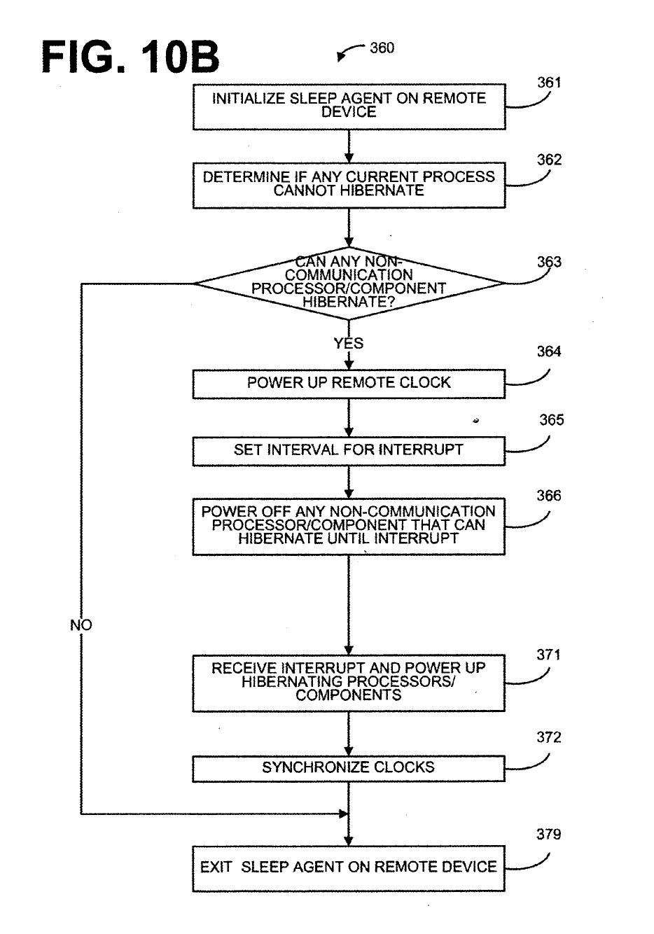

At step 215, it is determined, if nothing is selected. If it is determined that step 215 that something was selected, then remote device Power Management system 200 skips to step 217. However, if it is determined at step 215 that nothing was selected, then the sleep agent is executed at step 216. The sleep agent is herein defined in further detail in FIG. 10B. The sleep agent attempts to conserve the battery when the device is on, but not currently performing a critical task. In one embodiment of the present invention, the sleep agent is performed instead of placing the device in standby or hibernation.

At step 217, it is determined that there are more messages and processes to be performed. If it is determined at step 217 that there are more messages and processes to be performed, then remote device Power Management system 200 returns to repeat steps 202 through 217. However, if it is determined at step 217 that there are no more processes or messages to be performed, then the remote device Power Management system 200 exit that step 219.

Illustrated in FIG. 5A is a flow chart describing operation of the configuration process 120 on a server 11 utilized in the exemplary Power Management system 100, as shown in FIGS. 1-3. The configuration process 120 collects the updates required to be pushed down or requested to remote mobile device 15, 17, 18, 19, and 20. The configuration process 120, after initialization, listens on a configurable port for connections from clients or a configuration message from server 11 at step 122.

After it receives a client connection from remote mobile device 15, 17, 18, 19, and 20 or configuration message from server 11, it determines if the configuration message to be sent to the remote mobile device 15, 17, 18, 19, and 20 is a bootstrap message at step 123. If it is determined at step 123 that a bootstrap message is not to be sent, then the configuration process 120 then skips to step 126. However, if it is determined at step 123, the bootstrap message is to be sent, the configuration process 120 sends the ID name, connection address of the server 11, and the check-in duration to remote mobile device 15, 17, 18, 19, and 20 at step 124. The configuration process 120 then returns to repeat steps 122 through 135.

In step 126, the configuration process 120 determines if the configuration message for remote mobile device 15, 17, 18, 19, and 20 is a server initiated update. If it is determined at step 126 that the message is a server initiated update, then the configuration process 120 skips to step 131. However, if it is determined at step 126 that the configuration message is not a server initiated update, then the configuration process 120 connects to the remote mobile device 15, 17, 18, 19, and 20 with an IP connection via an internet protocol (IP) socket at step 127. At step 128 the configuration process 120 sends the configuration command to the remote mobile device 15, 17, 18, 19, and 20 on the established IP connection. The configuration process 120 then skips to step 134.

At step 131, the configuration process 120 determines if the server initiated update is a settings update. If it is determined in step 131 that the update message is a settings update, then update settings are sent from the configuration process 120 to the remote mobile device 15, 17, 18, 19, and 20 at step 132. The configuration process 120 then skips to step 134. However, if it is determined at step 131 that the server initiated update is not a settings update, and the configuration process 120 sends the configuration command at step 133.

At step 134, the configuration process 120 then logs the success of the command or update for the remote mobile device 15, 17, 18, 19, and 20. At step 135, it is determined that there are more configuration messages to be processed. If it is determined at step 135 that there are more configuration messages to be processed, then the configuration process 120 returns to repeat steps 122 through 135. However, if it is determined at step 135 that there are no more configuration messages to be processed, then the configuration process 120 exits at step 139.

In an alternative embodiment, the configuration process 120 will maintain a connection to the client on the remote mobile device 15, 17, 18, 19, and 20 until the client terminates the connection.

Illustrated in FIG. 5B is a flow chart describing an operation of the configuration agent 220 on a remote mobile device 15, 17, 18, 19, and 20 utilized in remote device Power Management system 200, as shown in FIGS. 1-4B. The configuration agent 220 collects the updates required to be pushed down or requested by remote mobile device 15, 17, 18, 19, and 20. The configuration agent 220, after initialization, listens on a configurable port for connections or a configuration message from server 11 at step 222.

After it receives a connection or configuration message from server 11, configuration agent 220 determines if the configuration message being sent to the remote mobile device 15, 17, 18, 19, and 20 is a bootstrap message at step 223. If it is determined at step 223 that a bootstrap message is not to be sent, then the configuration agent 220 then skips the step 226. However, if it is determined at step 223, the bootstrap message is to be sent, the configuration agent 220 receives the ID name, connection address of the server 11, and the check-in duration for the remote mobile device 15, 17, 18, 19, and 20 at step 224. The configuration agent 220 then returns to repeat steps 222 through 237.

Step 226, the configuration agent 220 determines if the configuration message for remote mobile device 15, 17, 18, 19, and 20 is a server initiated update. If it is determined at step 226 that the message is a server initiated update, then the configuration agent 220 skips to step 231. However, if it is determined at step 226 that the configuration message is not a server initiated update, then the configuration agent 220 connects the remote mobile device 15, 17, 18, 19, and 20 to server 11 with an IP connection via an internet protocol (IP) socket at step 227. At step 228 the configuration agent 220 receives the configuration command to the remote mobile device 15, 17, 18, 19, and 20 on the established IP connection. The configuration agent 220 then skips to step 234.

At step 231, the configuration agent 220 determines if the server initiated update is a settings update. If it is determined in step 231 that the update message is a settings update, then update settings is processed for the remote device by the configuration agent 220 at step 232. The configuration agent 220 then skips to step 234. However, if it is determined at step 231 that the server initiated update is not a settings update, and then the configuration agent 220 logs the configuration command at step 233.

At step 234, the configuration agent 220 then determines if the update was a success. If the update was applied with success, then the configuration agent 220 then notifies the server 11 that the command was successfully applied at step 236. Otherwise, if it is determined at step 234 that the update was not a success, then the configuration agent 220 notifies the server 11 that the command update was not successful at step 235.

At step 237, it is determined if there are more configuration messages to be processed. If it is determined at step 237 that there are more configuration messages to be processed, then the configuration agent 220 returns to repeat steps 222 through 237. However, if it is determined at step 237 that there are no more configuration messages to be processed, then the configuration agent 220 exits at step 239.

Illustrated in FIG. 6A is a flow chart describing operation of the emergency process 140 utilized by the exemplary Power Management system 100, as shown in FIGS. 2A-4A. The emergency process 140 collects tracking information from remote mobile device 15, 17, 18, 19, and 20 in order to calculate updated Power Management information, and forward that information onto third-party providers such as 911 or service centers.

First, the emergency process 140 is initialized on the server 11 at step 141, and performs similar functions as the initialization of the Power Management system 100 as described above. The initialization also includes the establishment of data values for particular data structures utilized in the emergency process 140. At step 142, the emergency process 140 determines if the message received is to activate an emergency beacon. If it is determined at step 142 that the message received is not to activate an emergency beacon, then the emergency process 140 then skips to step 146.

However, if it is determined that the message received is to activate an emergency beacon or is updating information with regard to emergency process that is flagged as an emergency, then the emergency process 140 sets a flag in database 12, indicating that remote mobile device 15, 17, 18, 19, and 20 has an emergency. At step 144, updated tracking information is received. At step 145, the emergency process 140 terminates all non-emergency messaging to the remote mobile device 15, 17, 18, 19, and 20. This is done in order to prohibit any occurrence of a server 11 from distracting the user of remote mobile device 15, 17, 18, 19, and 20, limit usage of available network bandwidth, limit remote device processing power and control battery usage.

At step 146, emergency process 140 calculates the updated Power Management information in the duration of the emergency and forwards this data to third-party providers such as 911 or a service center. The third party provider or service center indicated would be third party server 21 and databases 22 (FIG. 1).

At step 151, the emergency process 140 determines if the user of a remote mobile device 15, 17, 18, 19, and 20 is canceling the emergency. The user would cancel the emergency by deactivating the emergency button. If it is determined at step 151 that the user is canceling the emergency, then the emergency process 140 resets the emergency flag in database 12 for the remote mobile device 15, 17, 18, 19, and 20 and skips to step 156. In an alternative embodiment, the user cannot cancel the emergency activation and the remote mobile device 15, 17, 18, 19, and 20 locks automatically.

However, if it is determined at step 151 that the user is not canceling the emergency, then the emergency process 140 determines if the third party is canceling the emergency at step 152. If it is determined at step 152 that a third party is not canceling the emergency, then the emergency process 140 locks the remote mobile device 15, 17, 18, 19, and 20 in the emergency state on the remote device at step 153, and then skips to step 156. However, if it is determined at step 152 that a third party is canceling the emergency, the emergency process 140 sends a cancel and acknowledgment at step 154 and skips to step 156.

At step 156, the emergency process 140 of the present invention determines if more emergency messages are to be processed. If it is determined at step 156 that there are more emergency messages to be processed, the emergency process 140 then returns to repeat steps 142 through 156. However, if it is determined at step 156 that there are no more emergency messages to be processed, then the emergency process 140 exits at step 159.

Illustrated in FIG. 6B is a flow chart describing operation of the emergency agent 240 utilized by remote device Power Management system 200, as shown in FIGS. 2A-4B. The emergency agent 240 collects tracking information on remote mobile device 15, 17, 18, 19, and 20 in order to send emergency Power Management information to server 11.

First, the emergency agent 240 is initialized on the remote mobile device 15, 17, 18, 19, and 20 at step 241, and performs similar functions as the initialization of remote device Power Management system 200 as described above. The initialization also includes the establishment of data values for particular data structures utilized in the emergency agent 240. At step 242, the emergency agent 240 determines if the message received is to activate an emergency. In the preferred embodiment, an emergency is activated by pressing the emergency button. If it is determined at step 242 that the emergency button was not pressed, then the emergency agent 240 then skips to step 253.

However, if it is determined that the emergency button was pressed, and then the emergency agent to 240 then sets the display countdown at step 243. The displayed countdown of the amount of time that the user has to deactivate the emergency button before the emergency sequence is placed into service.

At step 244, it is determined if the emergency button was the pressed longer than the display countdown. This is an order to enable a user to deactivate an emergency process before the emergency sequence is placed into service. If it is determined at step 244 that the emergency button duration was not sufficient, then the emergency agent to 240 then skips to step 253.

However, if it is determined at step 244 that the button was depressed for a sufficient duration, the emergency agent to 240 blocks the input to the remote mobile device 15, 17, 18, 19, and 20 at step 245. At step 246, the remote mobile device 15, 17, 18, 19, and 20 starts the Power Management data including ID cell tower signal strength, duration since activation, date and time of the message, GPS location then includes latitude and longitude, the number of satellites detected by the remote device and the battery level of the remote device and any other required status information.

At step 251, the emergency agent to 240 then sends an SMS message with the tracking data to server 11 indicating that there is an emergency situation. At step 252, emergency agent to 240 then places a call to 911 or a user defined pre-set third-party call center.

At step 253, the emergency agent 240 determines if the user deactivates the emergency process. If it is determined in step 253 that the user does deactivate the emergency situation, then the emergency agent 240 then returns to repeat steps 242 through 255. However, if it is determined in step 253 that the user did not attempt to deactivate the emergency situation, then the emergency agent 240 sends an SMS message with updated tracking data to server 11 on a predetermined time interval until the emergency agent 240 is deactivated

At step 255, the emergency agent 240 of the present invention determines if more emergency messages are to be processed. If it is determined at step 255 that there are more emergency messages to be processed, and the emergency agent 240 then returns to repeat steps 242 through 256. However, if it is determined at step 256 that there are no more emergency messages to be processed, then the emergency agent 240 exits at step 259.

Illustrated in FIG. 7A is a flow chart describing operation of the tracking process 160 utilized by the exemplary Power Management system 100, as shown in FIGS. 2A-4A. The tracking process 160 is responsible for non-emergency tracking information and determining if the remote device being tracked is within the parameters.

First, at step 161, the tracking process 160 is initialized on the server 11 and performs similar functions as the initialization of the Power Management system 100 as described above. The initialization also includes the establishment of data values for particular data structures utilized in the tracking process 160.

At step 162, the tracking process 160 receives tracking information from the remote mobile device 15, 17, 18, 19, and 20 and updates the tracking information in database 12. At step 163, the tracking process 160 forwards the tracking information to a tracking server or third party server 21. This is in order to provide tracking information to an enterprise.

At step 164, it is determined that the track information is within known parameters. This determines that the track of the remote mobile device 15, 17, 18, 19, and 20 is within predetermined boundaries. In one example, the remote device could be assigned to an operator of delivery trucks such as for example, but not limited to, UPS trucks, United States Postal Service, Federal Express or the like. In other examples, the remote mobile device 15, 17, 18, 19, and 20 could be provided to one's teenage child to make sure that the child does not go out of state. If it is determined in step 164 that the track information is not within known parameters, and the tracking process 160 skips to step 166.

At step 165, if the tracking data is within known parameters it sets an active notification to the third party server 21.

At step 166, it is determined if there are more tracking messages to be processed. If it is determined that there are more tracking messages to be processed, then the tracking process 160 returns to repeat steps 162 through 166. However, if it is determined at step 166 that there are no more tracking messages to be processed, then the tracking process 160 exits at step 169.

Illustrated in FIG. 7B is a flow chart describing operation of the tracking agent 260 utilized by remote device Power Management system 200 of the present invention, as shown in FIGS. 2B-4B. The tracking agent 260 is responsible for non-emergency tracking information collected by the remote mobile device 15, 17, 18, 19, and 20.

First, at step 261, the tracking agent 260 is initialized on the remote mobile device 15, 17, 18, 19, and 20 and performs similar functions as the initialization of remote device Power Management system 200 as described above. The initialization also includes the establishment of data values for particular data structures utilized in the tracking agent 260.

At step 262, the tracking agent 260 receives a message to start collecting tracking information on the remote mobile device 15, 17, 18, 19, and 20. At step 263, in tracking agent to 260 gets various Power Management information. The Power Management information, collected includes, but are is not limited to, cell tower ID, signal strength, duration since activation of the tracking, date and time of the tracking parameters, GPS location including latitude and longitude, number of satellites detected, the altitude of the remote device, and other status info.

At step 264, the parameters are implemented. The handset starts recording and sending of location data based on the parameters.

At step 265, the tracking agent calls the GPS agent. The GPS agent generates tracking data based on the GPS hardware on remote mobile device 15, 17, 18, 19, and 20. The GPS agent is herein defined in further detail in FIG. 10A.

At step 266, it is determined if more tracking data is to be generated. If it is determined that there are more tracking messages to be generated, then the tracking agent 260 returns to repeat steps 262 through 266. However, if it is determined at step 266 that there are no more tracking messages to be generated, then the tracking agent 260 exits at step 269.

Illustrated in FIG. 8A is a flow chart describing operation of the negotiate communication link process 180 utilized by the Exemplary Power Management system 100 on server 11, as shown in FIGS. 2A-4A. The negotiate communication link process 180 starts the message processing by determining the priority and communication link needed by a message to be sent or received.

Once the priority of a message is determined, the negotiate communication link process 180 will determine which communication method to use in order to transmit or receive the message. If the negotiate communication link process 180 has registered the server 11 as IP capable, the message will be sent over the IP link. Otherwise, the message will be sent via SMS via SMPP or other protocols if the server 11 is SMS capable.

First, at step 181, the negotiate communication link process 180 is initialized on the server 11 and performs similar functions as the initialization of the Power Management system 100 as described above. The initialization also includes the establishment of data values for particular data structures utilized in the negotiate communication link process 180.

At step 182, the priority of the message to be sent or received on server 11 is determined. At step 183, it is determined if the message to be sent or received is high priority. If it is determined at step 183 that the message to be sent or received is not a high priority, then the negotiate communication link process 180 proceeds to step 188. However, if it is determined at step 183 that the message to be sent or received is high priority, then the negotiate communication link process 180 determines if the message is to be sent at step 184. If it is determined at step 184 that the message is not to be sent, then the negotiate communication link process 180 skip to step 187.

However, if it is determined at step 184 that the message to be processed is a high-priority send message, then the message is converted to SMS or USSD. The negotiate communication link process 180 will attempt to send a message via SMS via SMPP or other protocols before dropping down to the default of USSD at step 186. The negotiate communication link process 180 then skips to step 196.

At step 187, the negotiate communication link process 180 places the message received in the high priority queue and then skips to step 196.

At step 188, it is determined if the normal priority message is to be sent. If it is determined at step 188 that the normal message is not to be sent, but instead to be received, then the negotiate communication link process 180 then skips to step 195. However, if it is determined at step 188 that the normal priority message is to be sent, then it determines in step 191 if an IP connection is available for the message. If it is determined in step 191 that an IP connection is not available, then the negotiate communication link process 180 send a message via SMS or USSD by repeating steps 185 through 186. However, if it is determined at step 191 that an IP connection is available, then the negotiate communication link process 180 sends the message at step 192 utilizing the IP communication link.

At step 193, it is determined if the IP message was successfully sent. If it is determined at step 193 that the IP message was successfully sent, the negotiate communication link process 180 then skips to step 196. However, if it is determined at step 193 that the IP message was not successfully sent, then the negotiate communication link process 180 determines if the maximum retry limit for sending a message on any IP communication link has been reached at step 194.

If it is determined that the maximum retry count has been reached, then the negotiate communication link process 180 changes the communication link being utilized by sending the message via SMS or USSD by repeating steps 185 through 186. However, if it is determined at step 194 that the maximum retry count had not been exceeded, then the negotiate communication link process 180 repeats steps 192 and 193 to attempt to resend the message using the IP connection.

At step 195, the negotiate communication link process 180 places the normal priority message being received in the normal queue on server 11.

At step 196, the negotiate communication link process 180 determines if there are more messages to be sent and received. If it is determined at step 196 that there are more messages to be sent and received, the negotiate communication link process 180 then returns to repeat steps 182 through 196. However, if it is determined that there are no more messages to be sent or received, the negotiate communication link process 180 then exits at step 199.

Illustrated in FIG. 8B is a flow chart describing operation of the negotiate communication link agent 280 utilized by remote device Power Management system 200 of the present invention, as shown in FIGS. 2B-4B. The negotiate communication link agent 280 starts the message process by determining the priority and communication link utilized by a message to be sent or received on remote mobile device 15, 17, 18, 19, and 20.

Once the priority of a message is determined, the negotiate communication link agent 280 will determine which communication method to use in order to transmit or receive the message. If the negotiate communication link agent 280 has registered the remote mobile device 15, 17, 18, 19, and 20 as IP capable, the message will be sent over the IP link. Otherwise, the message will be sent via SMS over SMPP or other protocols if the device is SMS capable.

First, at step 281, the negotiate communication link agent 280 is initialized on the remote mobile device 15, 17, 18, 19, and 20 and performs similar functions as the initialization of remote device Power Management system 200 as described above. The initialization also includes the establishment of data values for particular data structures utilized in the negotiate communication link agent 280.

At step 282, the priority of the message to be sent or received on the remote mobile device 15, 17, 18, 19, and 20 is determined. At step 283, it is determined if the message to be sent or received is high priority. If it is determined at step 283 that the message to be sent or received is not a high priority, then the negotiate communication link agent 280 proceeds to step 288. However, if it is determined at step 283 that the message to be sent or received is high priority, then the negotiate communication link agent 280 determines if the message is to be sent at step 284. If it is determined at step 284 that the message is not to be sent, then the negotiate communication link agent 280 skips to step 287.

However, if it is determined at step 284 that the message to be sent is a high-priority send message, then the message is converted to SMS or USSD. The negotiate communication link agent 280 on the remote mobile device 15, 17, 18, 19, and 20 will attempt to send a message via SMS over SMPP or other protocols before dropping down to the default of USSD at step 286. The negotiate communication link agent 280 then skips to step 296.

At step 287, the negotiate communication link agent 280 places the message received in the high priority queue and then skips to step 296.

At step 288, it is determined if the normal priority message is to be sent. If it is determined at step 288 that the normal message is not to be sent, but instead to be received, then the negotiate communication link agent 280 then skips to step 295. However, if it is determined at step 288 that the normal priority message is to be sent, then it determines in step 291 if an IP connection is available for the message. If it is determined in step 291 that an IP connection is not available, then the negotiate communication link agent 280 send a message via SMS or USSD by repeating steps 285 through 286. However, if it is determined at step 291 that an IP connection is available, then the negotiate communication link agent 280 sends the message at step 282 utilizing the IP communication link.

At step 293, it is determined if the IP message was successfully sent. If it is determined at step 293 that the IP message was successfully sent, the negotiate communication link agent 280 then skips to step 296. However, if it is determined at step 293 that the IP message was not successfully sent, then the negotiate communication link agent 280 determines if the maximum retry limit for sending a message on any IP communication link has been reached at step 294. If it is determined that the maximum retry count has been reached, then the negotiate communication link agent 280 changes the communication link being utilized by sending the message via SMS or USSD by repeating steps 285 through 286. However, if it is determined at step 294 that the maximum retry count had not been exceeded, then the negotiate communication link agent 280 repeats steps 292 and 293 to attempt to resend the message using the IP connection on remote mobile device 15, 17, 18, 19, and 20.

At step 295, the negotiate communication link agent 280 places the normal priority message being received in the normal queue on remote mobile device 15, 17, 18, 19, and 20.

At step 296, the negotiate communication link agent 280 determines if there are more messages to be sent and received. If it is determined at step 296 that there are more messages to be sent and received, then the negotiate communication link agent 280 then returns to repeat steps 282 through 296. However, it is determined that there are no more messages to be sent or received, then the negotiate communication link agent 280 then exits at step 299.

Illustrated in FIG. 9 is a flow chart describing operation of the flashlight agent 320 utilized on the remote mobile device 15, 17, 18, 19, and 20 for remote device Power Management system 200 of the present invention, as shown in FIGS. 1 and 2B. The flashlight agent 320 energizes the screen so that it may act as a flashlight.

First, at step 321, the flashlight agent 320 is initialized on the remote mobile device 15, 17, 18, 19, and 20. The initialization also includes the establishment of data values for particular data structures utilized in the flashlight agent 320.

At step 322, it is determined if the SOS function is selected. If it is determined at step 322 that the flash SOS signal is selected, then the flashlight agent 320 then flashes the SOS signal at step 323 and skips to step 325. However, if it is determined at step 322 that the SOS is not selected, then the flashlight agent reverses and brightens the screen of the remote mobile device 15, 17, 18, 19, and 20 at step 324.

At step 325, the flashlight agent determines if the user has initiated the turnoff of either the flash SOS signal or the screen brighten function. If it is determined at step 325 that the user has not turned off the SOS signal or the screen brighten signal, then the flashlight agent 320 then returns to repeat steps 322-325. Otherwise, the flashlight agent 320 turns off the SOS signal or the screen-brighten signal at step 325 and exits at step 329.

FIG. 10A is a flow chart illustrating operation of the GPS agent 340 utilized on the remote device for the exemplarily Power Management system with the battery extension system of the present invention, as shown in FIG. 7B. The GPS agent 340 acquires GPS information and communicates the GPS information back to the exemplarily Power Management system 100 on server 11. The GPS agent 340 also utilizes the battery extension system of the present invention, where applicable to maximize the battery life between the transmissions of GPS information.

First, at step 341, the GPS agent 340 is initialized on the remote mobile device 15, 17, 18, 19, and 20 and performs similar functions as the initialization of remote device Power Management system 200 as described above. The initialization also includes the establishment of data values for particular data structures utilized in the GPS agent 340.

At step 342, the GPS agent 340 activates the GPS processor (not shown). At step 343, the GPS agent 340 determines if the GPS processor is operating normally. If it is determined that the GPS processor is not operating normally, then the GPS agent 340 then returns to step 342 to reattempt the activation of the GPS processor. If it is determined at step 343 that the GPS processor is operating normally, then the GPS agent 340 obtained a GPS position fix of the remote mobile device 15, 17, 18, 19, and 20 at step 344. At step 345, the GPS agent 340 then determines if the GPS position fix was successfully acquired. If it is determined at step 345 that the attempt to obtain the GPS position fix was successful, then the GPS agent 340 then skips the step 347.

If it is determined at step 345, that the attempt to obtain the GPS position was unsuccessful, then the GPS agent 340 calls the sleep agent at step 346. The sleep agent provides the battery extension system of the present invention, where applicable to maximize the battery life between the transmissions of GPS information. The sleep agent is herein defined in further detail in FIG. 10B. After performing the sleep agent, the GPS agent 340 returns to repeat step 342-345.

At step 347, the GPS agent 340 performs the negotiate communication link agent 280 then attempts to transmit the GPS position data to the Power Management system 100 on server 11. The negotiate communication link agent 280 was defined herein in further detail in FIG. 8B. At step 351, it is determined if the communication link negotiated at step 347 is operational. If it is determined at, step 351, that the communication link negotiated at step 347 is operational, then the GPS agent 340 skips to step 353.

However, if it is determined at step 351 that the communication link negotiated at step 347 is not operational, then the GPS agent 340 then saves the GPS data message to a high priority queue at step 352. After saving the data, the GPS agent 340 then performs the sleep agent at step 346. As stated previously, the sleep agent is herein defined in further detail in FIG. 10B. The sleep agent attempts to determine if any current process, processor or component within the remote mobile device 15, 17, 18, 19, and 20 can hibernate, (i.e. powered off for a limited time). After performing the sleep agent at step 346, the GPS agent 340 then returns to repeat steps 342 through 351.

At step 353, the GPS agent 340 then sends the tracking data to the Power Management system 100 on server 11. At step 354, the GPS agent 340 determines if there are more GPS positions to acquire. If it is determined at step 354 that there are more GPS positions to acquire, then the GPS agent 340 returns to repeat steps 342-354. However, if it is determined at step 354 that there are no more GPS positions to obtain, then the GPS agent 340, then exits at step 359.

FIG. 10B is a flow chart illustrating example of the operation of the sleep agent 360 utilized on the remote mobile device 15, 17, 18, 19, and 20 with the remote device Power Management system 200 with the battery extension system of the present invention, as shown in FIGS. 4B and 10A. The sleep agent attempts to conserve the battery when the device is on, but not currently performing a critical task. In one embodiment of the present invention, the sleep agent is performed instead of placing the device in standby or hibernation.

First, at step 361, the sleep agent 360 is initialized on the remote mobile device 15, 17, 18, 19, and 20 and performs similar functions as the initialization of remote device Power Management system 200 as described above. The initialization also includes the establishment of data values for particular data structures utilized in the sleep agent 360.

At step 362, the sleep agent 360 determines if any current process or processes cannot hibernate. The hibernation is the temporary interruption of power to the processor or component on remote mobile device 15, 17, 18, 19, and 20 for a predetermined time. At step 263, it is determined if any noncommunication processor or component can hibernate. If it is determined at step 363 that no non-communication processor or component is available for hibernation, then the sleep agent 360 skips to step 379. However, if it is determined at step 363 that at least one non-communication processor or component is available for hibernation, then the sleep agent 360 powers up the remote clock (not shown) at step 364. The power up process also includes the synchronization of the remote clock with the system clock for the at least one non-communication processor or component is available for hibernation. At step 365, the sleep agent 360 such the interval for interrupts. In one embodiment, the interval for interrupt is a factory preset time. In another embodiment, the interval for interrupt can be a user setting.

At step 366, the sleep agent 360 then powers off any non-communication processor or component they can hibernate into receiving the interrupt to reactivate that non-communication processor or component. After waiting a predetermined interval, the remote clock sends an interrupt to the hibernating non-communication processor and component to power up at step 371. After powering up the non-communication processor and component, the sleep agent 360 then synchronizes the system clock with the remote clock at step 372. The sleep agent 360 then exits at step 379.

Any process descriptions or blocks in flow charts should be understood as representing modules, segments, or portions of code, which include one or more executable instructions for implementing specific logical functions or steps in the process. Alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention.

It will be apparent to those skilled in the art that many modifications and variations may be made to embodiments of the present invention, as set forth above, without departing substantially from the principles of the present invention. All such modifications and variations are intended to be included herein within the scope of the present invention, as defined in the claims that follow.

What is claimed is:

1. A system for remotely monitoring and managing operation of a mobile device, the system having a server configured to communicate electronically with the mobile device, the mobile device having conventional voice and data communication capabilities and further having a processor, an operating system, and software code stored in memory on the mobile device, the software code including instructions executable by the processor that performs the steps of:
establishing a data communication link with the server;
receiving, at a radio interface layer (RIL) of the mobile device, an electronic communication from the server, the electronic communication having a header containing one or more special characters that identify whether the electronic communication is one of a plurality of RIL commands or one of a plurality of conventional mobile communications;
if the electronic communication is determined to be one of the plurality of RIL commands, passing the electronic communication to a command manager and by-passing the operating system installed on the mobile device;
performing the instructions contained in the electronic communication using the command manager without activating the operating system installed on the mobile device; and
if the electronic communication is determined to be one of the plurality of conventional mobile communications, passing the electronic communication to the operating system installed on the mobile device for handling by the conventional voice and data communication capabilities of the mobile device.

2. The system of claim 1 further comprising the step of determining if the electronic communication is one of the plurality of RIL commands or one of the plurality of conventional mobile communications based on the header of the electronic communication.

3. The system of claim 2 wherein the step of determining if the electronic communication is one of the plurality of RIL commands or one of the plurality of conventional mobile communications is performed by a RIL proxy.

4. The system of claim 3 wherein the RIL proxy forwards the electronic communication to the command manager if the electronic communication is determined to be one of the plurality of RIL commands.

5. The system of claim 3 wherein the RIL proxy forwards the electronic communication to the operating system installed on the mobile device if the electronic communication is determined to be one of the plurality of conventional mobile communications.

6. The system of claim 1 wherein one of the plurality of RIL commands includes a header, a body containing command instructions and parameter values, and a final set of characters, the header identifying the start of the RIL command, and the final set of characters identifying the end of the RIL command.

7. The system of claim 1 wherein one of the plurality of conventional mobile communications includes one or more of a voice data, text message, SMS data, MMS and data.

8. The system of claim 1 wherein one of the plurality of RIL commands causes the mobile device to initiate a power management operation to shut down non-essential applications and functions of the mobile device to minimize battery power consumption.

9. The system of claim 1 wherein one of the plurality of RIL commands causes the mobile device to initiate a tracking operation to cause the mobile device to transmit location data at periodic intervals.

10. The system of claim 1 wherein one of the plurality of RIL commands causes the mobile device to initiate an emergency condition operation to cause the mobile device to reduce power consumption, transmit location data at periodic intervals, and restrict operation to a limited number of applications and functions on the mobile device.
